(19) United States
(12) Patent Application Publication
(10) Pub. No.: US 2026/0222873 A1
(43) Pub. Date: Jul. 30, 2026

(54) DEVICE TRIGGERED BEAM MEASUREMENT REPORTING

(71) Applicant: QUALCOMM Incorporated, San Diego, CA (US)

(72) Inventors: Qiaoyu LI, Beijing (CN); Tao LUO, San Diego, CA (US); Hamed PEZESHKI, San Diego, CA (US); Mahmoud TAHERZADEH BOROUJENI, San Diego, CA (US)

(21) Appl. No.: 19/146,822

(22) PCT Filed: Feb. 17, 2023
(86) PCT No.: PCT/CN2023/076769

§ 371 Date: Jul. 9, 2025

(51) Int. Cl. H04W 24/10; H04W 24/08

(52) U.S. Cl. CPC H04W 24/10; H04W 24/08

(57) ABSTRACT

Methods, systems, and devices for wireless communication are described. A UE may transmit a first report to a network entity. The first report may indicates a predicted channel measurement associated with a reference signal resource. Additionally, the UE may determine that the predicted channel measurement satisfies a trigger condition. Based on the predicted channel measurement satisfying the trigger condition, the UE may include a request in the first report. The request may be to transmit a second report that indicates an actual channel measurement associated with the predicted channel measurement. The UE may receive a grant from the network entity in response to the request. The grant may indicate an uplink resource that the UE may use to transmit the second report.

### CROSS REFERENCE

The present Application for Patent is a 371 national phase filing of International Patent Application No. PCT/CN2023/076769 by LI et al., entitled “DEVICE TRIGGERED BEAM MEASUREMENT REPORTING,” filed Feb. 17, 2023, assigned to the assignee hereof, and expressly incorporated by reference herein.

### FIELD OF TECHNOLOGY

The following relates to wireless communication, including device triggered beam measurement reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some multiple-access communications systems, a network entity may perform beam management procedures to identify beam pairs for wireless communications between the network entity and a UE. As part of a beam management procedure, the UE may report channel characteristics measured at the UE to the network entity. In some cases, existing techniques for reporting channel characteristics may be deficient.

### SUMMARY

The described techniques relate to improved methods, systems, devices, and apparatuses that support device triggered beam measurement reporting. For example, the described techniques provide one or more frameworks for event triggered measurement reporting. In some examples, a UE may transmit a first report to a network entity. The first report may indicates a predicted channel measurement associated with a reference signal resource. Additionally, the UE may determine that the predicted channel measurement satisfies a trigger condition. Based on the predicted channel measurement satisfying the trigger condition, the UE may include a request in the first report. For example, the request may be to transmit a second report that indicates an actual channel measurement associated with the predicted channel measurement. The UE may receive a grant from the network entity in response to the request. The grant may indicate an uplink resource that the UE may use to transmit the second report.

A method for wireless communication at a UE is described. The method may include transmitting, to a network entity, a first report that indicates a predicted channel measurement associated with a reference signal resource, determining that the predicted channel measurement satisfies a trigger condition, where the first report indicates a request to transmit a second report that indicates an actual channel measurement associated with the predicted channel measurement based on the predicted channel measurement satisfying the trigger condition, and receiving, from the network entity in response to the request, a grant of at least an uplink resource to transmit the second report.

An apparatus for wireless communication at a UE is described. The apparatus may include a processor, memory coupled with the processor, and instructions stored in the memory. The instructions may be executable by the processor to cause the apparatus to transmit, to a network entity, a first report that indicates a predicted channel measurement associated with a reference signal resource, determine that the predicted channel measurement satisfies a trigger condition, where the first report indicates a request to transmit a second report that indicates an actual channel measurement associated with the predicted channel measurement based on the predicted channel measurement satisfying the trigger condition, and receive, from the network entity in response to the request, a grant of at least an uplink resource to transmit the second report.

Another apparatus for wireless communication at a UE is described. The apparatus may include means for transmitting, to a network entity, a first report that indicates a predicted channel measurement associated with a reference signal resource, means for determining that the predicted channel measurement satisfies a trigger condition, where the first report indicates a request to transmit a second report that indicates an actual channel measurement associated with the predicted channel measurement based on the predicted channel measurement satisfying the trigger condition, and means for receiving, from the network entity in response to the request, a grant of at least an uplink resource to transmit the second report.

A non-transitory computer-readable medium storing code for wireless communication at a UE is described. The code may include instructions executable by a processor to transmit, to a network entity, a first report that indicates a predicted channel measurement associated with a reference signal resource, determine that the predicted channel measurement satisfies a trigger condition, where the first report indicates a request to transmit a second report that indicates an actual channel measurement associated with the predicted channel measurement based on the predicted channel measurement satisfying the trigger condition, and receive, from the network entity in response to the request, a grant of at least an uplink resource to transmit the second report.

In some examples of the method, apparatuses, and non-transitory computer-readable medium described herein, transmitting the first report may include operations, features, means, or instructions for transmitting the first report during a first duration, where the predicted channel measurement may be associated with a second duration subsequent to the first duration.

Some examples of the method, apparatuses, and non-transitory computer-readable medium described herein may further include operations, features, means, or instructions for receiving, from the network entity, a reference signal transmitted using a second reference signal resource associated with the reference signal resource and transmitting, to the network entity using the uplink resource, the second report that indicates the actual channel measurement associated with the predicted channel measurement, where the actual channel measurement may be of the reference signal.

In some examples of the method, apparatuses, and non-transitory computer-readable medium described herein, the reference signal resource includes a virtual resource and the second reference signal resource includes a channel measurement resource (CMR).

Some examples of the method, apparatuses, and non-transitory computer-readable medium described herein may further include operations, features, means, or instructions for identifying the trigger condition, where determining that the predicted channel measurement satisfies the trigger condition may be based on identifying the trigger condition.

Some examples of the method, apparatuses, and non-transitory computer-readable medium described herein may further include operations, features, means, or instructions for receiving, from the network entity, an indication of the trigger condition, where identifying the trigger condition may be based on the received indication.

Some examples of the method, apparatuses, and non-transitory computer-readable medium described herein may further include operations, features, means, or instructions for transmitting, to the network entity, an indication of the identified trigger condition.

In some examples of the method, apparatuses, and non-transitory computer-readable medium described herein, determining that the predicted channel measurement satisfies the trigger condition may include operations, features, means, or instructions for determining that a difference between the predicted channel measurement and a second predicted channel measurement associated with a second reference signal resource satisfies a threshold, where the predicted channel measurement and the second predicted channel measurement may be associated with a same duration.

In some examples of the method, apparatuses, and non-transitory computer-readable medium described herein, the first report indicates a set of multiple actual channel measurements that may be associated with a set of multiple reference signal resources include the second reference signal resource and the second reference signal resource corresponds to a strongest channel measurement of the set of multiple actual channel measurements.

In some examples of the method, apparatuses, and non-transitory computer-readable medium described herein, the second reference signal resource corresponds to a transmission configuration indicator (TCI) state associated with a previously scheduled physical downlink control channel (PDCCH) transmission or a previously scheduled physical downlink shared channel (PDSCH transmission.

In some examples of the method, apparatuses, and non-transitory computer-readable medium described herein, determining that the predicted channel measurement satisfies the trigger condition may include operations, features, means, or instructions for determining that a confidence level associated with the predicted channel measurement satisfies a threshold.

In some examples of the method, apparatuses, and non-transitory computer-readable medium described herein, the first report includes a bitmap or a combinatorial index that indicates the request.

In some examples of the method, apparatuses, and non-transitory computer-readable medium described herein, the first report includes a periodic channel state information (CSI) report and the second report includes an aperiodic CSI report.

In some examples of the method, apparatuses, and non-transitory computer-readable medium described herein, the reference signal resource includes a CMR.

A method for wireless communication at a UE is described. The method may include transmitting, to a network entity, a first report that indicates at least a first predicted channel measurement associated with a first reference signal resource of a set of reference signal resources, determining whether the first predicted channel measurement satisfies a trigger condition, and transmitting, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

An apparatus for wireless communication at a UE is described. The apparatus may include a processor, memory coupled with the processor, and instructions stored in the memory. The instructions may be executable by the processor to cause the apparatus to transmit, to a network entity, a first report that indicates at least a first predicted channel measurement associated with a first reference signal resource of a set of reference signal resources, determine whether the first predicted channel measurement satisfies a trigger condition, and transmit, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

Another apparatus for wireless communication at a UE is described. The apparatus may include means for transmitting, to a network entity, a first report that indicates at least a first predicted channel measurement associated with a first reference signal resource of a set of reference signal resources, means for determining whether the first predicted channel measurement satisfies a trigger condition, and means for transmitting, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

A non-transitory computer-readable medium storing code for wireless communication at a UE is described. The code may include instructions executable by a processor to transmit, to a network entity, a first report that indicates at least a first predicted channel measurement associated with a first reference signal resource of a set of reference signal resources, determine whether the first predicted channel measurement satisfies a trigger condition, and transmit, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

In some examples of the method, apparatuses, and non-transitory computer-readable medium described herein, determining whether the first predicted channel measurement satisfies the trigger condition may include operations, features, means, or instructions for determining that the first predicted channel measurement fails to satisfy the trigger condition, where the second report indicates that the first channel measurement includes the first actual channel measurement based on the first predicted channel measurement failing to satisfy the trigger condition.

In some examples of the method, apparatuses, and non-transitory computer-readable medium described herein, determining whether the first predicted channel measurement satisfies the trigger condition may include operations, features, means, or instructions for determining that the first predicted channel measurement satisfies the trigger condition, where the second report indicates that the first channel measurement includes the second predicted channel measurement based on the first predicted channel measurement satisfying the trigger condition.

In some examples of the method, apparatuses, and non-transitory computer-readable medium described herein, transmitting the second report may include operations, features, means, or instructions for transmitting a bit that indicates the set of channel measurements includes predicted channel measurements or actual channel measurements.

In some examples of the method, apparatuses, and non-transitory computer-readable medium described herein, transmitting the second report may include operations, features, means, or instructions for transmitting a first indication that the first channel measurement includes the second predicted channel measurement or the first actual channel measurement and transmitting a second indication that the second channel measurement includes a third predicted channel measurement or a second actual channel measurement.

In some examples of the method, apparatuses, and non-transitory computer-readable medium described herein, the first indication includes a first bit or a first combinatorial index associated with the first channel measurement and the second indication includes a second bit or a second combinatorial index associated with the second channel measurement.

In some examples of the method, apparatuses, and non-transitory computer-readable medium described herein, determining whether the first predicted channel measurement satisfies the trigger condition may include operations, features, means, or instructions for determining that a confidence level associated with the first predicted channel measurement satisfies a threshold.

Some examples of the method, apparatuses, and non-transitory computer-readable medium described herein may further include operations, features, means, or instructions for identifying the trigger condition, where determining that the first predicted channel measurement satisfies the trigger condition may be based on identifying the trigger condition.

Some examples of the method, apparatuses, and non-transitory computer-readable medium described herein may further include operations, features, means, or instructions for receiving, from the network entity, an indication of the trigger condition, where identifying the trigger condition may be based on the received indication.

Some examples of the method, apparatuses, and non-transitory computer-readable medium described herein may further include operations, features, means, or instructions for transmitting, to the network entity, an indication of the identified trigger condition.

A method for wireless communication at a network entity is described. The method may include obtaining a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition, outputting, in response to the request, a grant of at least an uplink resource to be used to transmit the second report, and obtaining the second report that indicates the actual channel measurement associated with the predicted channel measurement based on outputting the grant.

An apparatus for wireless communication at a network entity is described. The apparatus may include a processor, memory coupled with the processor, and instructions stored in the memory. The instructions may be executable by the processor to cause the apparatus to obtain a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition, outputting, in response to the request, a grant of at least an uplink resource to be used to transmit the second report, and obtain the second report that indicates the actual channel measurement associated with the predicted channel measurement based on outputting the grant.

Another apparatus for wireless communication at a network entity is described. The apparatus may include means for obtaining a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition, means for outputting, in response to the request, a grant of at least an uplink resource to be used to transmit the second report, and means for obtaining the second report that indicates the actual channel measurement associated with the predicted channel measurement based on outputting the grant.

A non-transitory computer-readable medium storing code for wireless communication at a network entity is described. The code may include instructions executable by a processor to obtain a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition, outputting, in response to the request, a grant of at least an uplink resource to be used to transmit the second report, and obtain the second report that indicates the actual channel measurement associated with the predicted channel measurement based on outputting the grant.

In some examples of the method, apparatuses, and non-transitory computer-readable medium described herein, the predicted channel measurement may be associated with a duration and the method, apparatuses, and non-transitory computer-readable medium may include further operations, features, means, or instructions for outputting a reference signal using a second reference signal resource associated with the reference signal resource, where the actual channel measurement may be of the reference signal.

In some examples of the method, apparatuses, and non-transitory computer-readable medium described herein, the reference signal resource includes a virtual resource and the second reference signal resource includes a CMR.

In some examples of the method, apparatuses, and non-transitory computer-readable medium described herein, the first report includes a bitmap or a combinatorial index that indicates the request.

A method for wireless communication at a network entity is described. The method may include obtaining a first report that indicates at least a first predicted channel measurement associated with a reference signal resource of a set of reference signal resources and obtaining a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

An apparatus for wireless communication at a network entity is described. The apparatus may include a processor, memory coupled with the processor, and instructions stored in the memory. The instructions may be executable by the processor to cause the apparatus to obtain a first report that indicates at least a first predicted channel measurement associated with a reference signal resource of a set of reference signal resources and obtain a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

Another apparatus for wireless communication at a network entity is described. The apparatus may include means for obtaining a first report that indicates at least a first predicted channel measurement associated with a reference signal resource of a set of reference signal resources and means for obtaining a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

A non-transitory computer-readable medium storing code for wireless communication at a network entity is described. The code may include instructions executable by a processor to obtain a first report that indicates at least a first predicted channel measurement associated with a reference signal resource of a set of reference signal resources and obtain a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

In some examples of the method, apparatuses, and non-transitory computer-readable medium described herein, transmitting the second report may include operations, features, means, or instructions for obtaining one or more bits that indicate the set of channel measurements includes predicted channel measurements or actual channel measurements.

### BRIEF DESCRIPTION OF THE DRAWINGS

FIGS. 1 and 2 each illustrate an example of a wireless communications system that supports device triggered beam measurement reporting in accordance with one or more aspects of the present disclosure.

FIG. 3 illustrates an example of a reporting scheme that supports device triggered beam measurement reporting in accordance with one or more aspects of the present disclosure.

FIGS. 4A and 4B each illustrate an example of a report format that supports device triggered beam measurement reporting in accordance with one or more aspects of the present disclosure.

FIGS. 5 and 6 each illustrate an example of a process flow that supports device triggered beam measurement reporting in accordance with one or more aspects of the present disclosure.

FIGS. 7 and 8 illustrate diagrams of devices that support device triggered beam measurement reporting in accordance with one or more aspects of the present disclosure.

FIG. 9 illustrates a diagram of a communications manager that supports device triggered beam measurement reporting in accordance with one or more aspects of the present disclosure.

FIG. 10 illustrates a diagram of a system including a device that supports device triggered beam measurement reporting in accordance with one or more aspects of the present disclosure.

FIGS. 11 and 12 illustrate diagrams of devices that support device triggered beam measurement reporting in accordance with one or more aspects of the present disclosure.

FIG. 13 illustrates a diagram of a communications manager that supports device triggered beam measurement reporting in accordance with one or more aspects of the present disclosure.

FIG. 14 illustrates a diagram of a system including a device that supports device triggered beam measurement reporting in accordance with one or more aspects of the present disclosure.

FIGS. 15 through 18 illustrate flowcharts showing methods that support device triggered beam measurement reporting in accordance with one or more aspects of the present disclosure.

### DETAILED DESCRIPTION

In some wireless communications systems, a communication device may perform one or more beam management procedures to identify one or more beam pairs for wireless communications between the communication device and one or more other communication devices. Some beam management procedures may include beam selection, transmit beam refinement, and receive beam refinement, among other possible examples. A UE may report channel characteristics to a network entity as part of a beam management procedure. For example, the UE may transmit a CSI report that indicates one or more channel characteristics measured at the UE.

In some examples, to improve a performance of one or more beam management procedures, the UE may use an artificial intelligence (AI) or machine learning (ML) model to predict channel characteristics based on actually measured channel characteristics. Actually measured channel characteristics may be obtained at the UE during a measurement occasion and precited channel characteristics may be associated with a prediction occasion subsequent to the measurement occasion (e.g., a future time instance). In other words, an actually measured channel characteristic may correspond to an actual measurement result obtained at the UE based on a measurement performed at the UE during a measurement occasion (e.g., a time instance during which a reference signal may be transmitted to the UE via a downlink beam). Accordingly, a precited channel characteristic may correspond to a prediction of a measurement result (e.g., a predicted measurement result) obtained at the UE (e.g., via an AI or ML (AI/ML) model) for a future time instance, which may be referred to herein as a prediction occasion.

In some examples, the network entity may configure the UE to periodically transmit a CSI report that includes actual measurement results, predicted measurement results, or both. In some examples, the network entity may configure the UE to transmit CSI reports in accordance with a measure-to-prediction cycle ratio. In such an example, the UE may report predicted measurement results for multiple prediction occasions in a single CSI report. In some examples, however, the UE may determine that a predicted measurement result may be relatively unreliable. For example, the UE may rotate or change locations relatively quickly, which may degrade an accuracy associated with a predicted measurement result. In such examples, the UE may determine that the predicted measurement result may be relatively unreliable. Accordingly, the UE may determine to obtain an actual measurement during a prediction occasion associated with the relatively unreliable predicted measurement result. In some examples, however, the UE may lack a mechanism, much less an effective mechanism, for requesting uplink resources to report the actual measured result to the network entity.

Aspects of the present disclosure generally relate to device triggered beam measurement reporting. For example, various aspects of the present disclosure provide a framework for indicating a request to transmit an actual measurement result in response to a triggering event. In some examples, a UE may obtain a predicted measurement result associated with a reference signal resource, such as a CMR or a virtual resource. A CMR may refer to a reference signal resource used for channel measurements and a virtual resource may refer to an allocated resource, which may be mapped to a physical resource. In some examples, the UE may determine that the predicted measurement result satisfies a trigger condition. In response to determining that the predicted measurement result satisfies the trigger condition (e.g., in response to a triggering event), the UE may request to transmit an actual measurement result associated with the predicted measurement result. For example, the UE may transmit a first report (e.g., a first CSI report) that indicates the predicted measurement result and a request to transmit a second report (e.g., a second CSI report, such as an aperiodic CSI report) that indicates the actual measurement result associated with the predicted measurement result. In some examples, in response to the request, the network entity may trigger the UE to transmit the second report. For example, the network entity may transmit a grant of an uplink resource that the UE may use to transmit the second report.

In some examples, the network entity may configure the UE to report channel characteristics for a relatively large quantity of reference signal resources and measuring channel characteristics for each reference signal resource may lead to increased power consumption at the UE. Accordingly, the UE may report actually measured channel characteristics for a portion of the reference signal resources and report predicted channel characteristics for a remaining portion of reference signal resources. In other words, the UE may transmit a report that includes actually measured channel characteristics, predicted channel characteristics, or both. In some examples, however, the UE may lack a mechanism, much less an effective mechanism, for indicating whether a report includes predicted channel characteristics or an actually measured channel characteristics.

Various aspects of the present disclosure provide a framework for indicating a type of channel measurement include in a report. For example, a UE may transmit a first report to the network entity that indicates a first predicted channel measurement. The first predicted channel measurement may be associated with a reference signal resource. The UE may determine whether the first predicted channel measurement satisfies a trigger condition and transmit a second report to the network entity. The second report may indicate a channel measurement associated with the reference signal resource. Additionally, the second report may indicate whether the channel measurement includes a second predicted channel measurement associated with the reference signal resource or a first actual channel measurement associated with the reference signal resource. The channel measurement including the second predicted channel measurement or the first actual channel measurement may be based on whether the first predicted channel measurement satisfies the trigger condition. In some examples, the channel measurement may include the second predicted channel measurement based on the first predicted channel measurement satisfying the trigger condition. Additionally, in some examples, the channel measurement may include the first actual channel measurement based on the first predicted channel measurement failing to satisfy the trigger condition.

Aspects of device triggered beam measurement reporting, as described herein, may provide one or more enhancements to beam management procedures. For example, various aspects of device triggered beam measurement reporting may provide one or more frameworks for event triggered measurement reporting that may lead to increased performance and reduced complexity for beam management procedures. Such frameworks may provide for overhead and latency reduction, among other possible benefits. Aspects of the disclosure are initially described in the context of wireless communications systems. Aspects of the disclosure are also described in the context of a reporting scheme, report formats, and process flows. Aspects of the disclosure are further illustrated by and described with reference to diagrams and flowcharts that relate to device triggered beam measurement reporting.

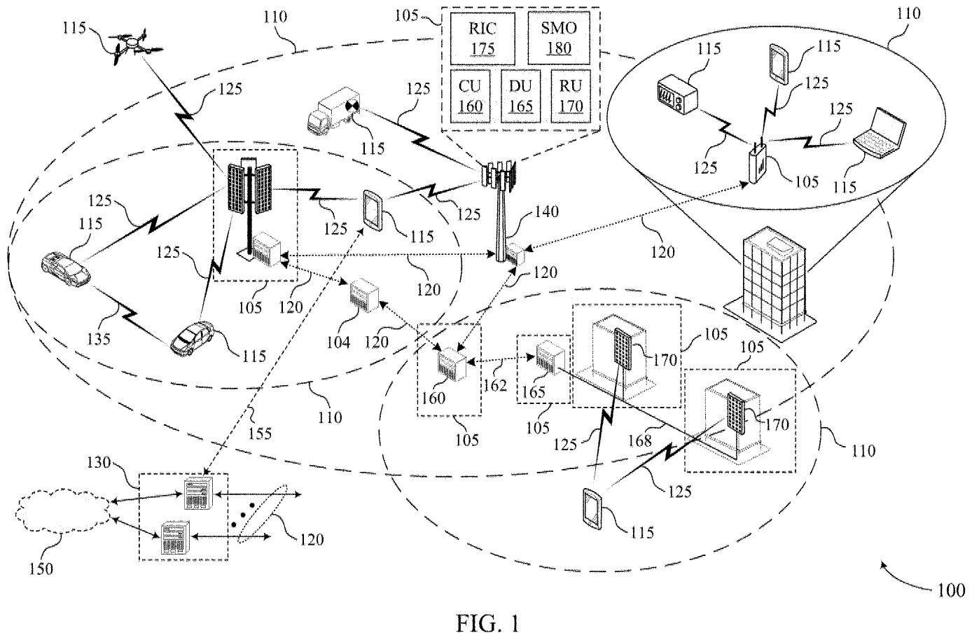

FIG. 1 illustrates an example of a wireless communications system 100 that supports device triggered beam measurement reporting in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support device triggered beam measurement reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as OFDM or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time-domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time-domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A network entity 105 may configure a UE 115 to report channel measurements for one or more reference signal resources (e.g., CMRs or virtual resources), for example, as part of a beam management procedure. A channel measurement may include one or more types of channel characteristics, such as a reference signal received power (RSRP) measurement, a signal to interference plus noise ratio (SINR) measurement, a rank indicator (RI), a PMI, and channel quality indicator (CQI). To improve a performance of the beam management procedure, the UE 115 may use an AI/ML model to predict channel measurements based on actually measured channel characteristics. In some examples, however, the UE 115 may determine that a predicted measurement result may be relatively unreliable. For example, the UE 115 may rotate or change locations relatively quickly, which may degrade an accuracy associated with a predicted measurement result. In such examples, the UE 115 may determine that the predicted measurement result may be relatively unreliable and to obtain an actual measurement during a prediction occasion associated with the predicted measurement result. In some examples, however, the UE 115 may lack a mechanism for requesting uplink resources to report the actual measured result to the network entity 105.

In some examples, the UE 115 may be configured with a framework for indicating a request to transmit an actual measurement result to the network entity 105 in response to a triggering event. For example, the UE 115 may obtain a predicted measurement result associated with a reference signal resource. The UE 115 may transmit a first report to the network entity that indicates a predicted measurement result and a request to transmit a second report that indicates the actual measurement result associated with the predicted measurement result. In some examples, the request to transmit the second report may be based on the UE 115 determining that the predicted measurement result satisfies a trigger condition. In other words, the UE 115 may request to transmit the second report in response to a triggering event. In some examples, in response to the request, the network entity 105 may trigger the UE 115 to transmit the second report. For example, the network entity 105 may transmit a grant of an uplink resource that the UE 115 may use to transmit the second report.

In some examples, the network entity 105 may configure the UE 115 to report channel characteristics for a relatively large quantity of reference signal resources and measuring channel characteristics for each reference signal resource may lead to increased power consumption at the UE 115. Accordingly, to reduce a quantity of actual measurements performed at the UE 115, the UE 115 may report actual measurement results for a portion of the reference signal resources and predicted measurement results for a remaining portion of reference signal resources. In some examples, however, the UE 115 may lack a mechanism for indicating whether a report includes actual measurement results or predicted measurement results, or both.

In some examples, the UE 115 may be configured with a framework for indicating a type of channel measurement include in a report. For example, the UE 115 may transmit a first report to the network entity 105 that indicates a first predicted channel measurement. The first predicted channel measurement may be associated with a reference signal resource. The UE 115 may determine whether the first predicted channel measurement satisfies a trigger condition and transmit a second report to the network entity 105. The second report may indicate a channel measurement associated with the reference signal resource and whether the channel measurement includes a second predicted channel measurement or a first actual channel measurement. In some examples, the channel measurement may include the second predicted channel measurement based on the first predicted channel measurement satisfying a trigger condition. Additionally, in some examples, the channel measurement may include the first actual channel measurement based on the first predicted channel measurement failing to satisfy the trigger condition. In some examples, enabling the UE 115 with one or more frameworks for event triggered beam measurement reporting may lead to increased performance and reduced complexity for beam management procedures, among other possible benefits.

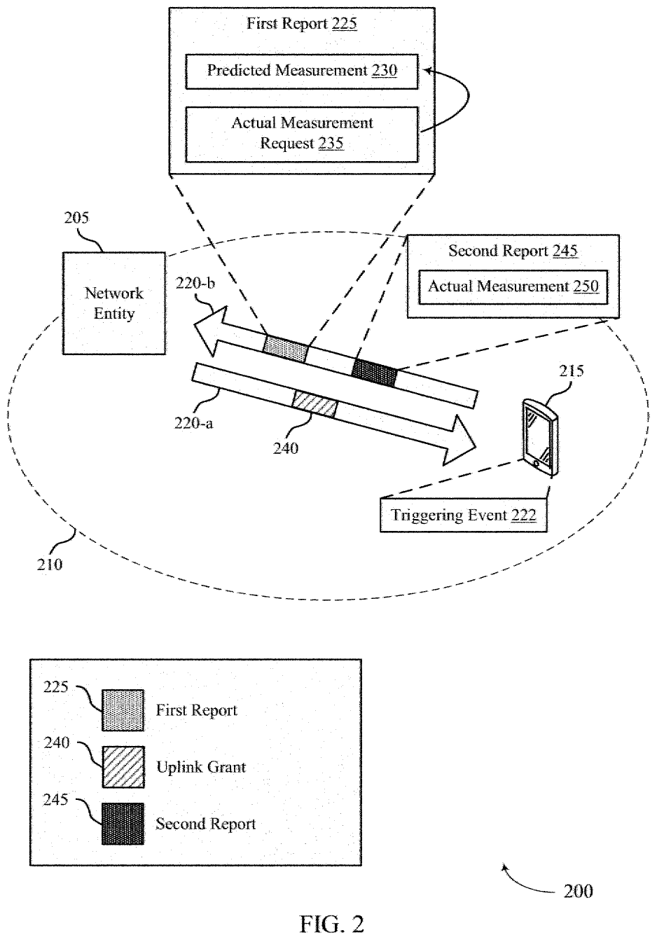

FIG. 2 illustrates an example of a wireless communications system 200 that supports device triggered beam measurement reporting in accordance with one or more aspects of the present disclosure. The wireless communications system 200 may implement or be implemented to realize or facilitate aspects of the wireless communications system 100. For example, the wireless communications system 200 may include a UE 215 and a network entity 205, which may be examples of the corresponding devices illustrated by and described with reference to FIG. 1. The network entity 205 may communicate with the UE 215 via one or more communication links 220 (e.g., a communication link 220-a and a communication link 220-b), which may be examples of a communication link (e.g., a Uu interface) illustrated by and described with reference to FIG. 1. For example, the communication link 220-a may be an example of a downlink and the communication link 220-b may be an example of an uplink. The UE 215 and the network entity 205 may communicate within a coverage area 210, which may be an example of a coverage area illustrated by and described with reference to FIG. 1.

In some examples, the network entity 205 and the UE 215 may use one or more beam management techniques to improve initial access procedures and tracking procedures and to identify a beam pair to be used for wireless communications between the UE 215 and the network entity 205 (e.g., a gNB). For example, the UE 215 may operate in one or more radio resource control (RRC) states, such as an idle state (e.g., indicated via an RRC_IDLE information element (IE)), an inactive state (e.g., indicated via an RRC_inactive IE), or a connected state (e.g., indicated via an RRC_connected IE). In some examples, the network entity 205 and the UE 215 may perform an initial access procedure subsequent to the UE 215 operating in the idle state or inactive state. During the initial access procedure the network entity 205 may perform a beam sweeping procedure (e.g., using relatively wide beams, such as synchronization signal block (SSB) beams). In some examples, while the UE 215 may be operating in the idle state or inactive state, the UE 215 may use tracking reference signals (TRSs), in which configurations for the TRS may be provided to the UE 215 in system information, such as for paging reception at the UE 215 (e.g., to conserver power). In a cell in which TRS may be available for the UE 215 to use while the UE 215 may be operating in the idle state or the inactive state, an availability of configured TRS may be informed to the UE 215 via signaling, such as L1 signaling (e.g., from the network entity 205).

In some examples, such as examples in which the UE 215 may be operating in the connected state, the UE 215 may receive downlink communications from the network entity 205 via a directional beam, such as may be used to transmit one or more reference signals. In some instances, an established connection (e.g., a communication link that may also be referred to as a radio link or a link) may be susceptible to blockages and degradation, which may cause interruptions in the radio link or a radio link failure. That is, the downlink communications from the network entity 205 may be dropped. To reduce the likelihood of radio link failures occurring or to recover after a radio link failure, the UE 215 may perform beam management procedures, such as a beam failure prevention procedure or a beam failure recovery procedure.

For example, the UE 215 may perform the beam failure recovery procedure to reestablish a connection with the network entity 205 and select another (e.g., different) beam pair for communications with the network entity 205. The beam pair may include a beam of the network entity 205 (e.g., a beam associated with a cell supported by the network entity 205) and a beam of the UE 215. In some examples, the beam management procedures may include one or more processes for downlink beam management, such as beam selection (P1), transmit beam refinement for the network entity 205 (P2), and receive beam refinement for the UE 215 (P3). In some examples, P1, P2, and P3 may include transmission of one or more reference signals from the network entity 205, such as SSBs or CSI-RS. Additionally, the beam management procedures may include one or more other processes for uplink beam management (e.g., U1, U2, U3), which may include transmission of uplink reference signals (e.g., sounding reference signals (SRS)) from the UE 215. In some examples, beam management may include reporting, such as L1-based (or L2-based) measurement reporting (e.g., L1-RSRP reporting, L1-SINR reporting), TCI state configurations (e.g., indications) from the network entity 205, dynamic TCI updates, uplink multi-panel selection, and maximum permitted exposure (MPE) mitigation, among other possible examples. In examples in which the UE 215 detects interruptions in the radio link or detects a radio link failure (e.g., based on measurements, such measurements on beam failure detection reference signals (BFD-RSs) or block error rate (BLER) measurements), the UE 215 may perform a recovery procedure (e.g., beam failure recovery procedure) to reduce a link interruption time or a link failure time. The recover procedure may be for a primary cell (PCell), primary cell of a secondary cell group (PSCell), or a secondary cell (SCell). In some examples, the recover procedure may be based on a random access procedure (e.g., contention free random access (CFRA). Additionally, in some examples, the recover procedure may include transmission of a link recovery request (e.g., via a scheduling request). In some examples, the recovery procedure may be a medium access control control element (MAC-CE) based beam failure recover procedure (e.g., for an SCell).

In some examples, the UE 215 or the network entity 205, or both, may support AI/ML-based beam management. For example, the UE 215 (or the network entity 205) may support one or more AI/ML-based beam management cases for characterization and performance (e.g., baseline performance) evaluations. That is, the UE 215 may support AI/ML-based beam management for performance monitoring. An AI/ML-based beam management case may include spatial-domain downlink beam predictions. For example, the UE 215 may use AI/ML to predict measurements for a first set of beams (e.g., set A, a prediction target) based on measurement results (e.g., actual measurements) of reference signals transmitted to the UE 215 using a second set of beams (e.g., set B, a measurement source). Predicted measurements and actual measurements may include RSRP measurements or SINR measurements, among other possible examples of channel measurements.

In some examples, in the spatial-domain, set A and set B may be different. For example, set A may correspond to a first set of reference signal resources (e.g., SSB resources or CSI-RS resources) and set B may correspond to a second set of reference signal resources (e.g., CSI-RS resources or SSB resources). That is, for spatial-domain downlink beam predictions, the UE 215 may predict measurements for the first set of reference signal resources. A reference signal resource (e.g., each reference signal resource) included in the first set of reference signal resources may correspond to a respective beam included in the first set of beams (e.g., set A). Additionally, the predicted measurements may be based on actual measurements of a set of reference signals transmitted using the second set of reference signal resources. A reference signal resource (e.g., each reference signal resource) included in the second set of reference signal resources may correspond to a respective beam (e.g., used to transmit the corresponding reference signal) included in the second set of beams (e.g., set B). In some other examples, set A may include a subset (e.g., a down-sampled version) of set B. That is, the first set of reference signal resources may include a subset of the second set of reference signal resources.

Another AI/ML-based beam management case may include time-domain downlink beam predictions. For example, the UE 215 may use AI/ML to predict measurements (e.g., RSRP measurements, SINR measurements) for a first set of beams (e.g., set A) based on historic measurement results of a second set of beams (e.g., set B). In some examples, set A may correspond to a set of reference signal resources at a first time occasion and set B may correspond to the same set of reference signal resources at a second time occasion (e.g., a previous time occasion). In some other examples, set A may correspond to a first set of reference signal resources and set B may correspond to a second set of reference signal resources that may be different from the first set of refence signals. For example, the second set of reference signals may correspond to SSB resources (e.g., the UE 215 may perform measurements of SSBs transmitted using relatively wide beams) and the first set of reference signals may correspond to CSI-RS resources (e.g., the UE 215 may predict measurements for CSI-RS that may be transmitted using relatively narrow beams). In some examples, beams in set A and set B may be in a same frequency range. That is, the first set of reference signal resources and the second set of reference signal resources may include frequencies within a same frequency range.

In some examples, the UE 215 may be configured to determine a respective quantity of beams (e.g., reference signal resources) to be included in set A and set B. Additionally, the UE 215 may select set B out of the beams (e.g., reference signal resources) in set A (e.g., according to a fixed pattern, a random pattern), for example, based on the determined quantity of beams to be included in set B. In some examples, the UE 215, may be configured to determine whether set A and set B are to be different (e.g., whether set A may include relatively narrow beams and set B may include relatively wide beams). Accordingly, the UE 215 may determine a quasi co-location (QCL) relationship between beams in set A and beams in set B. In some examples, set A may be for downlink beam predictions and set B may be for downlink beam measurements. Additionally, in some examples, the UE 215 may be configured with one or more codebook constructions of set A and set B.

In some examples, such as for spatial-domain beam predictions, the wireless communications system 200 may support use of a UE-side AI/ML model for beam management that may include L1 signaling from the UE 215 to report information associated with an AI/ML model inference (e.g., prediction) to the network entity 205. In such examples, one or more beams used for downlink communications with the UE 215 may be based on the AI/ML model inference. That is, one or more beams used for downlink communications with the UE 215 may be based on an output of AI/ML model inference at the UE 215. In some examples, the report may include predicted L1-RSRP measurements (or L1-SINR measurements) corresponding to one or more beams (e.g., one or more reference signal resources).

In some other examples, such as for time-domain predictions, the wireless communications system 200 may support use of a UE-side AI/ML model for beam management that may include L1 signaling from the UE 215 to report information associated with an AI/ML model inference to the network entity 205. In such examples, one or more beams (e.g., reference signal resources) at a quantity (N) of future time instances (e.g., time occasions) may be based on the AI/ML model inference. That is, one or more beams used for downlink communications with the UE 215 at a quantity of future time occasions may be based on an output of the AI/ML model inference at the UE 215. In some examples, the UE 215 may be configured with a value of N.

Additionally, for time-domain predictions, the wireless communications system 200 may support use of a UE-side AI/ML model for beam management that may include L1 signaling from the UE 215 to report information associated with an AI/ML model inference to the network entity 205. In some examples, one or more beams (e.g., reference signal resources) at a quantity (N) of future time instances (e.g., time occasions) may be based on an output of the AI/ML model inference (e.g., at the UE 215). In some examples, the UE 215 may be configured with a value of N.

In some examples, the report may include predicted L1-RSRP measurements corresponding to one or more beams (e.g., one or more reference signal resources). In some examples, the report may include information regarding a timestamp corresponding to the reported one or more beams (e.g., the reported one or more reference signal resources). In some examples, the timestamp information may be explicitly indicated via the report or implicitly indicated via the report.

In some examples, for spatial-domain predictions and for time-domain predictions with a UE-side AI/ML model, the wireless communications system 200 may support model monitoring with potential down-selection. For example, the wireless communications system may support UE-side model monitoring in which the UE 215 may monitor performance metrics associated with the AI/ML model or with wireless communications between the UE 215 and the network entity 205 (or both). In some examples, the UE 215 may make determinations regarding model selection, activation, deactivation, switching, and fallback operations, among other examples. Additionally, or alternatively, the wireless communications system 200 may support network-side model monitoring in which the network entity 205 may monitor performance metrics associated with the AI/ML model or with wireless communications between the UE 215 and the network entity 205 (or both). Additionally, in some examples, the network entity 205 may make determinations regarding model selection, activation, deactivation, switching, and fallback operations, among other examples. The wireless communications system 200 may support hybrid model monitoring in which the UE 215 may monitor one or more performance metrics and the network entity 205 may make determination regarding model selection, activation, deactivation, switching, and fallback operations.

In some examples, such as for spatial-domain predictions or time-domain predictions with a UE-side AI/ML model and network-side model monitoring, the network entity 205 may monitor one or more performance metrics and make determinations regarding model selection, activation, deactivation, switching, and fallback operations. Additionally, in some examples of network-side model monitoring for a network-side AI/ML model (e.g., for spatial-domain predictions and for time-domain predictions) the UE 215 may be configured to perform beam measurements and transmit a report for model monitoring. In some examples, such as for spatial-domain predictions or for time-domain predictions with a network-side AI/ML model, the UE 215 may support one or more L1 beam reporting enhancement for AI/ML model inference. For example, the UE 215 may report measurement results of multiple (e.g., more than 4) beams in one reporting instance. That is, the UE 215 may report measurement results of multiple (e.g., more than 4) reference signal resources in one reporting instance. Additionally, the UE 215 may support one or more other L1 reporting enhancements.

In some examples, the UE 215 may use one or more AI/ML models (e.g., a UE-side AI/ML model) for spatial-domain predictions associated with reference signal resources or time-domain predictions associated with reference signal resources (or both) based on measurements (e.g., historical measurements) performed at the UE 215. That is, the UE 215 may use an AI/ML model to predict and report future beam characteristics based on historical measurements. In other words, the UE 215 may use the AI/ML model to predict measurement results associated with reference signal resources based on actual measurement results associated with the reference signal resources or other reference signal resources. That is, the predicted measurement results may be associated with a first set of reference signal resources and the actual measurement results may be associated with a second set of reference signal resources, which may be different from (or the same as) the first set of reference signal resources.

In some examples, the UE 215 may be configure to report the predicted measurement results and the actual measurement results in a single reporting occasion (e.g., in a single report, in a single payload). That is, the UE 215 may be configured to transmit a report (e.g., an L1 report, such as a CSI report) during a reporting occasion that may include one or more actual measurement results and one or more predicted measurement results. An actual channel measurement result may correspond to a measurement performed at the UE 215 during a measurement occasion. In other words, an actual channel measurement may be obtained at the UE 215 based on the UE 215 performing a measurement during a time instance in which a reference signal may be transmitted to the UE 215 using a reference signal resource associated with the actual measurement result. That is, an actual channel measurement may be of a reference signal transmitted to the UE 215 using a reference signal resource associated with the actual measurement result Additionally, a predicted measurement result may correspond to a prediction of a measurement during a prediction occasion (e.g., a future time instance, an occasion subsequent to the reporting occasion). The report may include multiple prediction results for multiple future time instances. In some examples, however, the UE 215 may determine that a predicted measurement result may be relatively unreliable.

For example, the UE 215 may support performance monitoring (e.g., autonomous performance monitoring) for AI/ML-based beam predictions. In such an example, the UE 215 may monitor an accuracy associated with predicted measurement results. For example, considering UE-side AI/ML inference for time-domain (or spatial-domain) beam predictions (e.g., reference signal resource predictions), the network entity 205 (e.g., a gNB) may configure (e.g., pre-configure) the UE 215 with a measure-to-prediction cycle ratio. In such an example, the UE 215 may report predicted measurement results (e.g., all predicted measurement results) regarding multiple future prediction cycles (e.g., prediction occasions) in a single CSI report. In some examples, however, the UE 215 may make an observation (e.g., internally, such that only the UE 215 may be aware of the observation) that may impact a performance of beam predictions (e.g., time-domain beam predictions) at the UE 215. For example, the UE 215 may rotate (e.g., suddenly, relatively quickly), which may lead to degraded prediction accuracy.

In some examples, the UE 215 may determine that a confidence level regarding one or more of the predicted measurement results may be relatively low. For example, the UE 215 may determine that a confidence level associated with one or more of the predicted measurement results (e.g., time-domain prediction results included in the report) may satisfies a threshold. In some examples, such as in response to the UE 215 observing that the prediction accuracy of a predicted measurement result is relatively low, the UE 215 may determine to perform a measurement during a prediction occasion associated with the predicted measurement. In some examples, however, the UE 215 may lack a mechanism, much less an effective mechanism, for requesting uplink resources to feedback the actually measured result. Additionally, the UE 215 may lack a mechanism, much less an effective mechanism, to request transmission of reference signals, for example if transmission of reference signals may not be supported during the prediction occasion. That is, the UE 215 may determine to report an actual measurement result for a predicted measurement result that may be associated with a virtual resource. In such an example, the UE 215 may determine to request transmission of a CMR (e.g., scheduling of a reference signal resource), such that the UE 215 may actually perform the measurement.

In some examples, device triggered beam measurement reporting, as described herein, may provide one or more mechanisms for the UE 215 to request uplink resources to report actual measurement results and, in some examples, request transmission of reference signals for the actual measurements. For example, in accordance with device triggered beam measurement reporting, the UE 215 may transmit signaling (e.g., a report, such as a sunny day prediction report) that indicates such requests. In other words, the UE 215 may support UE (event triggered) actual beam measurement reporting for AI/ML-based beam prediction performance monitoring. For example, the UE 215 may transmit a UE event-triggered actual beam measurement report to the network entity 205 for AI/ML-based time-domain beam prediction performance monitoring. In some examples, the UE 215 may include additional payload in a report (e.g., a CSI report) carrying a predicted measurement result (e.g., predicted future beams) to indicate whether an actual measurement result (e.g., for a reference signal resource associated with the predicted measurement result) may be reported or whether a reference signal may be transmitted (e.g., using the reference signal resource or another reference signal resources associated with the reference signal resource). In some examples, UE event triggered actual beam measurement reporting may be extended to spatial-domain beam prediction performance monitoring.

The UE 215 may transmit a first report 225 (e.g., an L1 report, such as a CSI report) to the network entity 205 during a reporting occasion. The first report 225 may be an example of an event-triggered actual beam measurement report for AI/ML-based beam prediction performance monitoring. In some examples, through the first report 225 (e.g., a CSI report, such as an aperiodic CSI report), the UE 215 may report predicted channel characteristics (e.g., including L1-RSRP, L1-SINR, RI, PMI, and CQI) regarding a quantity of reference signal resources, such as CMRs or virtual resources. In some examples, virtual resource may refer to reference signal resources in which reference signals (e.g., prediction targets) may not be transmitted or may not be scheduled to be transmitted. Additionally, in some examples, CMRs may refer to resources used for transmission of reference signals such as SSBs or CSI-RSs, among other examples.

As illustrated in the example of FIG. 2, the first report 225 may indicate a predicted channel measurement result (e.g., a predicted measurement 230) associated with a first reference signal resource. The first reference signal resource may be an example of a CMR or a virtual resource and the predicted measurement 230 may be an example of an L1-RSRP measurement, an L1-SINR measurement, an RI, a PMI, a CQI, or another type of channel characteristic. In some instances, the first report 225 may include one or more actual measurement results. For example, the first report 225 may include the predicted measurement 230 and one or more actual measurements. In some examples, the predicted measurement 230 may be based on an actual channel measurement included in the first report 225. For examples in which the first report 225 includes one or more actual measurements, the actual measurements may be performed at the UE 215 during a measurement occasion prior to the reporting occasion. Additionally, the predicted measurement 230 may be associated with a prediction occasion that occurs subsequent to the reporting occasion.

Through the same CSI report (e.g., the first report 225), the UE 215 may indicate a request to the network entity 205 (e.g., a gNB) for the UE 215 to feedback actually measured channel characteristics associated with the predicted channel characteristics (e.g., associated with the predicted measurement 230). For example, the first report 225 may indicate an actual measurement request 235, which may indicate a request to transmit a second report 245 that indicates an actual measurement 250 (e.g., an actual channel measurement result) associated with the predicted measurement 230. The actual measurement request 235 may be based on an triggering event 222. For example, the UE 215 may transmit (e.g., indicate via the first report 225) the actual measurement request 235 based on the predicted measurement 230 satisfying a trigger condition. That is, the triggering event 222 may correspond to the predicted measurement 230 satisfying the trigger condition.

For example, the UE 215 may determine that the predicted measurement 230 satisfies the trigger condition if a confidence level associated with the predicted measurement 230 satisfies a threshold. In such an example, the UE 215 may transmit an indication of the actual measurement request 235 (e.g., via the first report 225), such that the UE 215 may obtain the actual measurement 250 (e.g., during the prediction occasion associated with the predicted measurement 230) and report the actual measurement 250 to the network entity 205. The UE 215 may identify the triggering event 222 as part of performance monitoring (e.g., autonomous performance monitoring) for AI/ML-based beam predictions. That is, the UE 215 may determine that the confidence level associated with the predicted measurement 230 satisfies the threshold as part of performance monitoring for AI/ML-based beam predictions. In some examples, the UE 215 may use the actual measurement 250 to verify the associated prediction measurement result.

In some examples, the trigger condition (also referred to as an event trigger) may be hardcoded at the UE 215, for example, based on a configuration (e.g., a gNB configuration), UE reporting, or both. For example, the UE 215 may report (e.g., recommend) the trigger condition to the network entity 205, the UE 215 may be configured with the trigger condition by the network entity 205 (e.g., the trigger condition may be gNB controlled), or the UE 215 may be otherwise configured the trigger condition (e.g., in accordance with predefinition).

In some examples, the first reference signal resource associated with the predicted measurement 230 may be a virtual resource. In such examples, the network entity 205 may transmit a reference signal using a second reference signal resource (e.g., a CMR) that may be associated with the virtual resource (e.g., the first reference signal resource). That is, the UE 215 may expect the network entity 205 to transmit a reference signal using a second reference signal resource that may be associated with the virtual resource. Accordingly, in some examples, the actual measurement request 235 may indicate a request for the network entity 205 to transmit a reference signal for the actual measurement 250. In other words, the actual measurement request 235 may indicate a first request to transmit an actual measurement report (e.g., the second report 245) or a second request for actually transmitted reference signals (e.g., for a prediction cycle, also referred to as a prediction occasion), or both. That is, the actual measurement request 235 may indicate a first request to transmit the second report 245 or a second request for actually transmitted reference signals, or both. In some examples, the UE 215 may indicate the actual measurement request 235 via additional payload in the first report 225. In some examples, such as in response to the actual measurement request 235, the UE 215 may be scheduled with an uplink resource to transmit the second report 245. That is, in response to the actual measurement request 235, the UE 215 may expect to be scheduled with an uplink resource to report such future channel characteristics. For example, in response to the actual measurement request 235, the UE 215 may receive an uplink grant 240, which may indicate one or more uplink resources that the UE 215 may use for transmitting the second report 245.

In some examples, device triggered beam measurement reporting, as described herein, may provide improvements to beam management. For example, one or more aspects of device triggered beam measurement reporting may provide a framework for AI/ML for the air-interface (e.g., wireless communications) that may lead to increased performance and reduced complexity (e.g., for beam management). The framework may include beam predictions in time-domain or spatial-domain (or both), which may provide for overhead and latency reduction and beam selection accuracy improvements. In some examples, the framework may enable use of AI/ML for characterization and baseline performance evaluations. Accordingly, the framework may provide for AI/ML approaches that may be relatively diverse and support constraints on collaboration levels between the UE 215 and the network entity 205. In some examples, device triggered beam measurement reporting, as described herein, may provide for characterization of lifecycle management of an AI/ML model including model training, model deployment, model inference, model monitoring, model updating. In other words, device triggered beam measurement reporting (e.g., UE triggered actual beam measurement reporting) may be used for AI-based beam prediction performance monitoring.

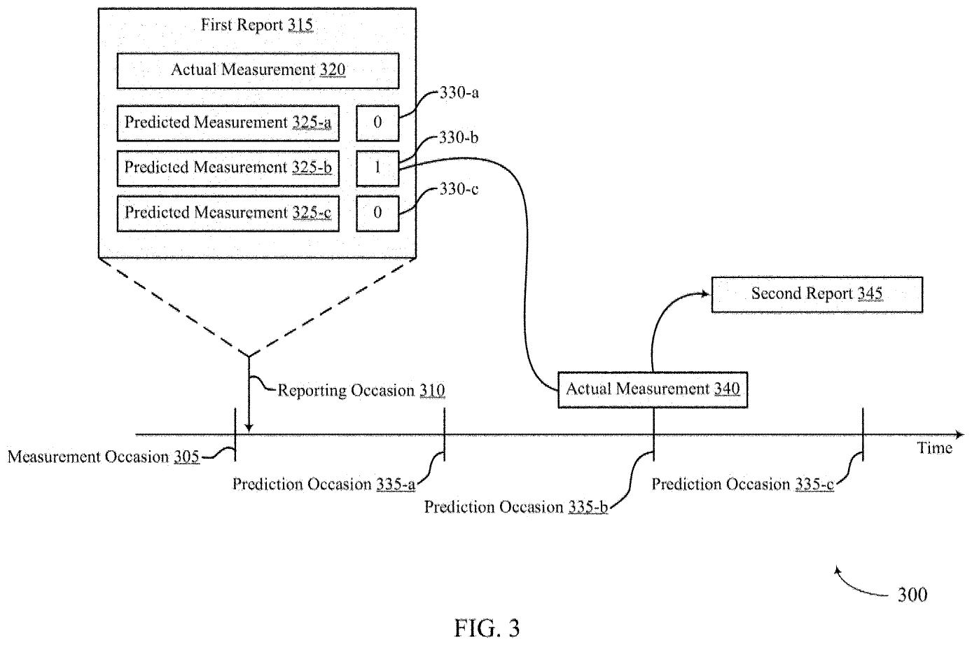

FIG. 3 illustrates an example of a reporting scheme 300 that supports device triggered beam measurement reporting in accordance with one or more aspects of the present disclosure. The reporting scheme 300 may implement or be implemented to realize or facilitate aspects of the wireless communications system 100 and the wireless communications system 200. For example, the reporting scheme 300 may be implemented at a UE and a network entity, which may be examples of the corresponding devices illustrated by and described with reference to FIGS. 1 and 2.

The UE may report channel characteristics to the network entity, for example, as part of (or to improve) a beam management procedure at the network entity. In some examples, the UE may report actually measured channel characteristics (e.g., actual channel measurements) to the network entity based on a triggering event. For example, the UE may report actual channel measurements associated with time-domain (or spatial-domain) beam predictions to the network entity based on a triggering event. That is, in a first report transmitted to the network entity during a reporting occasion, the UE may report predicted channel characteristics (e.g., predicted channel measurements) for one or more prediction occasions that occur subsequent to the reporting occasion. In other words, the UE may report predicted channel characteristics for one or more future time-domain occasions in a single reporting occasion, in which the future time-domain occasions may occur subsequent to the reporting occasion. Additionally, together with the reporting payload that includes the predicted channel characteristics, the UE may further indicate whether actually measured channel characteristics associated with one or more of the future time domain occasions may be further reported.

For example, the predicted channel characteristics may be reported via a CSI report and a payload of the CSI report may include a bitmap in which each bit (e.g., included in the bitmap) may be associated with a respective future time-domain occasion for which the UE may have reported predicted channel characteristics. In such an example, each bit (e.g., included in the bitmap) may indicate whether actually measured channel characteristics associated with the respective future time-domain occasion may be reported. In some examples, the UE may replace the bitmap with a combinatorial index (e.g., to reduce overhead). That is, the UE may use a bitmap or a combinatorial index to indicate whether actually measured channel characteristics associated with the future time-domain occasions may be reported.

As illustrated in the example of FIG. 3, the UE may transmit a first report 315 (e.g., the CSI report) during a reporting occasion 310. The first report 315 may indicate an actual measurement 320 as well as a predicted measurement 325-a, a predicted measurement 325-b, and a predicted measurement 325-c. The actual measurement 320 may be based on one or more measurements performed at the UE during a measurement occasion 305. The predicted measurements 325 may each be associated with a respective reference signal resource and a respective prediction occasion. That is, the predicted measurements 325 may each predict a measurement for the respective reference signal resource during the respective prediction occasion. For example, the predicted measurement 325-a may be associated with a prediction occasion 335-a, the predicted measurement 325-b may be associated with a prediction occasion 335-b, and the predicted measurement 325-c may be associated with a prediction occasion 335-c.

A payload of the first report 315 may include an indication of the actual measurement 320, an indication of the predicted measurement 325-a, an indication of the predicted measurement 325-b, an indication of the predicted measurement 325-c, and a bitmap (or combinatorial index) that may indicate whether one or more actual measurements may be reported for one or more of the predicted measurements 325. For example, the payload may include a bit 330-a associated with the predicted measurement 325-a, a bit 330-b associated with the predicted measurement 325-b, and a bit 330-c associated with the predicted measurement 325-c. A bit with a value set to “0” may indicate a lack of a request to report an actual measurement for the corresponding predicted measurement. Additionally, a bit with a value set to “1” may indicate a request to report an actual measurement for the corresponding predicted measurement. As illustrated in the example of FIG. 3, the bit 330-a may have a value of 0, which may indicate a lack of a request to report an actual measurement for the predicted measurement 325-a. Similarly, the bit 330-c may have a value of 0 and indicate a lack of a request to report an actual measurement for the predicted measurement 325-c.

In some examples, a lack of a request to report an actual measurement for a predicted measurement may indicate that the precited measurement fails to satisfy a trigger condition. For example, the UE may determine that the predicted measurement 325-a and the predicted measurement 325-c fail to satisfy the trigger condition. In some examples, however, the UE may determine that the predicted measurement 325-b satisfies the trigger condition. In other words, the UE may identify a triggering event associated with the predicted measurement 325-b. Accordingly, the UE may set a value of the bit 330-b to 1, such that the bit 330-b indicates a request to report an actual measurement 340 associated with the predicted measurement 325-b. In some examples, the request indicated via the bit 330-b may be an example of an actual measurement request as illustrated by and described with reference to FIG. 2. For example, the UE may include the bit 330-b in the payload of the first report 315 to request to transmit a second report 345 that indicates an actual measurement 340 performed at the UE during the prediction occasion 335-b (e.g., the prediction occasion associated with the predicted measurement 325-b).

In some examples, such as in response to transmitting the first report 315, the UE may be (e.g., may expect to be) triggered with the second report 345 (e.g., an aperiodic CSI report) and a reference signal resource (e.g., a CMR) associated with the second report 345 to measure and feedback actually measured channel characteristics (e.g., the actual measurement 340) for the prediction occasion 335-b. For example, in response to transmitting the first report 315 that indicates the request to transmit the second report 345 (e.g., that indicates the actual measurement 340 associated with the predicted measurement 325-b), the UE may receive an uplink grant from the network entity that triggers the UE to transmit the second report 345. The network entity may, in some examples, transmit the uplink grant via downlink control information (DCI). In some examples, the uplink grant may indicate an uplink resource for the UE to transmit the second report 345. In some examples, the network entity may trigger the UE to transmit the second report via one or more mechanisms, such as an aperiodic CSI report triggering mechanism. In some examples, the uplink resource may include a time-domain resource that occurs subsequent to the prediction occasion 335-b. That is, the UE may be configured to transmit the second report 345 subsequent to the prediction occasion 335-b (e.g., during which the UE may obtain the actual measurement 340).

Additionally, in some examples, the UE may be configured (e.g., triggered, scheduled) with a reference signal resource (e.g., a CMR) for the actual measurement 340. For example, the network entity may configure the UE with a reference signal resource that the network entity may use to transmit a reference signal to the UE (e.g., during the prediction occasion 335-b) and that the UE may use to perform the actual measurement 340. For example, the actual measurement 340 may be of the reference signal transmitted from the network entity via the reference signal resource. In some examples, the predicted measurement 325-b may be associated with (e.g., may consider) a virtual resource. In such examples, the reference signal resource (e.g., the CMR) associated with the second report 345 may be linked to (e.g., share one or more properties with) the virtual resource. That is, the UE may expect the CMR associated with the second report 345 to be linked with the virtual resource (e.g., in terms of beam shape or direction).

The triggering event associated with the predicted measurement 325-b may be one of multiple types of events that trigger the UE to request reporting actually measured channel characteristics for a future time-domain occasion, also referred to as a prediction occasion. In some examples, an event triggering the UE to request reporting actually measured channel characteristics for a future time-domain occasion, such as the prediction occasion 335-b, may be hardcoded at the UE (e.g., based on a predefinition), based on a configuration from the network entity (e.g., a gNB configuration), or based on a recommendation from the UE (e.g., a UE recommendation), or any combination thereof.

In some examples, the triggering event associated with the predicted measurement 325-b may include a value of the predicted measurement 325-b that is associated with the prediction occasion 335-b being larger than a value of a second predicted measurement that may also be associated with the prediction occasion 335-b. That is, the triggering event associated with the predicted measurement 325-b may include a value of a predicted L1-RSRP or a predicted L1-SINR for a first CMR that is associated with the prediction occasion 335-b being larger (e.g., by a threshold quantity (X)) than a value of a second predicted L1-RSRP or a second L1-SINR for a second CMR that may also be associated with the prediction occasion 335-b (e.g., may be associated with a same future time-domain occasion). For example, the predicted measurement 325-b may be more than X decibels (dB) greater (e.g., stronger) than the second predicted measurement. In other words, the triggering event may include a difference between the predicted measurement 325-b and the second predicted measurement satisfying a first threshold. In some examples, a value of the first threshold (e.g., a value of X) may be hardcoded at the UE (e.g., based on predefinition), based on a configuration from the network entity (e.g., a gNB configuration), or based on a recommendation from the UE (e.g., a UE recommendation), or any combination thereof.

In some examples, the second CMR may correspond to a CMR with a highest value in a relatively recent measurement occasion that excludes the first CMR. For example, the second CMR may correspond to a CMR with a strongest L1-RSRP or L1-SINR in a previous measurement occasion that excludes the first CMR. In other words, the first CMR may be different from other CMRs (e.g., including the second CMR) addressed in the previous measurement occasion. For example, the predicted measurement 325-b may be associated with the first CMR and may be based on the actual measurement 320. The actual measurement 320 may be obtained at the UE during the measurement occasion 305 and may correspond to a relatively largest measurement among the predicted measurements 325 indicated to the network entity during the reporting occasion 310. Additionally, the second predicted measurement may be associated with the second CMR and may be based on a second actual measurement obtained at the UE during a second measurement occasion (e.g., prior to the measurement occasion 305). In such an example, the second predicted measurement may correspond to a relatively highest (e.g., largest, strongest) measurement among measurements associated with the second measurement occasion. In other words, based on the second actual measurement (e.g., associated with the second CMR) obtained at the UE during the second measurement occasion (e.g., prior to the measurement occasion 305) the UE may determine that a downlink beam corresponding to the second CMR is a strongest beam during the prediction occasion 335-b. Additionally, based on the actual measurement 320 (e.g., associated with the first CMR) obtained at the UE during the measurement occasion 305, the UE may determine that another beam corresponding to the first CMR is the strongest beam during the prediction occasion 335-b. Accordingly, the UE may request to obtain the actual measurement 340 to confirm that the strongest beam during the prediction occasion 335-b changed from the beam corresponding to the second CMR to the beam corresponding to the first CMR.

In some other examples, the second CMR associated with the second measurement may correspond to a source reference signal of a TCI state of a previously (e.g., relatively recently) scheduled downlink channel, such as a PDCCH or PDSCH. In some examples, the UE may report actually measured channel characteristics together with (or separate from) the predicted channel characteristics, in which the actually measured channel characteristics may be associated with a time domain occasion preceding the future time domain occasion associated with the predicted channel characteristics.

In some other examples, the triggering event associated with the predicted measurement 325-b (e.g., the event triggering the UE to request to report the actual measurement 340) may include a confidence level associated with the predicted measurement 325-b (e.g., a predicted L1-RSRP or L1-SINR associated with the first CMR and regarding the prediction occasion 335-b) satisfying a confidence level threshold. A confidence level may satisfy the confidence level threshold if the confidence level is less than (e.g., falls below) the confidence level threshold. The confidence level threshold may correspond to (e.g., include, be defined in terms of) a percentage or standard deviation (e.g., in dBm) of a predicted measurement. In some examples, the confidence level threshold may be hardcoded at the UE (e.g., based on predefinition), based on a configuration from the network entity (e.g., a gNB configuration), or based on a recommendation from the UE (e.g., a UE recommendation), or any combination thereof. In some examples, requesting to report an actual measurement for a predicted measurement based on the predicted measurement satisfying a triggering condition may lead to reduced overhead for CSI reporting, among other possible benefits.

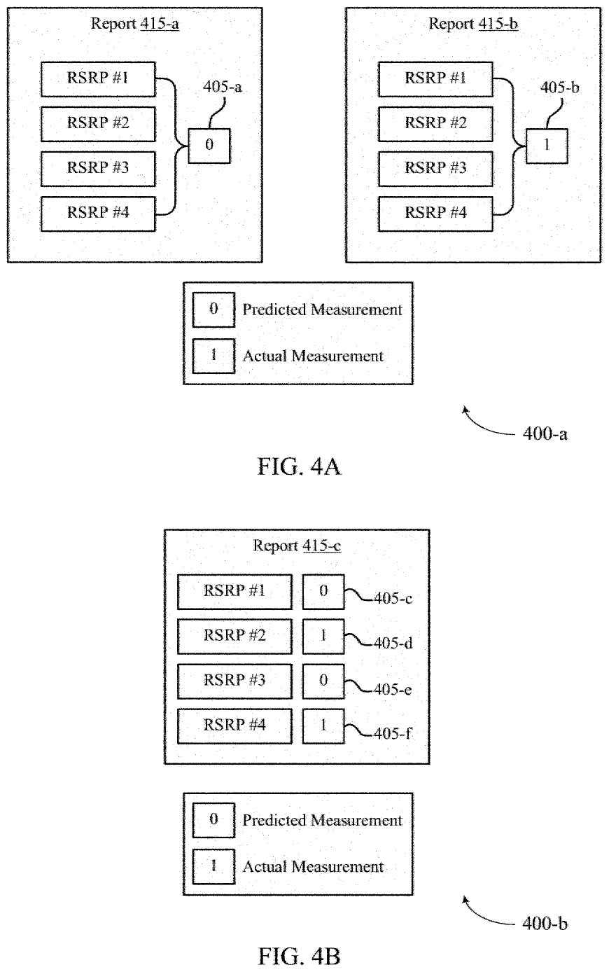

FIGS. 4A and 4B illustrate examples of report formats 400 that supports device triggered beam measurement reporting in accordance with one or more aspects of the present disclosure. The report formats 400 (e.g., a report format 400-a and a report format 400-b) may implement or be implemented to realize or facilitate aspects of the wireless communications system 100, the wireless communications system 200, and the reporting scheme 300. For example, the report formats 400 may be implemented at a UE or a network entity, or both, which may be examples of the corresponding devices illustrated by and described with reference to FIGS. 1-3.

The UE may support event triggered actual beam measurement reporting for spatial-domain beam prediction performance monitoring. In some examples, the UE may report channel characteristics for one or more reference signal resources out of a relatively large quantity of reference signal resources, in which a portion of the relatively large quantity of reference signal resources may not be actually measured by the UE. For example, the UE may report predicted channel characteristics or measured channel characteristics, or both, for one or more CMRs out of a relatively large quantity of r CMRs, in which a portion of the relatively large quantity of CMRs may not be actually measured by the UE. That is, the UE may be configured with a set of CMRs that includes a relatively large quantity of CMRs (e.g., hundreds of CSI-RSs or SSBs) and measuring each CMR of the set of CMRs may lead to increased power consumption at the UE. Accordingly, the UE may refrain from (e.g., may not be capable of) performing actual measurements during each measurement occasion associated with the set of CMRs. That is, the UE may measure a first portion of the set of CMRs and predict measurements (e.g., in the spatial-domain) for a second portion of the configured set of CMRs. For example, the UE may measure one or more CMRs of the set of CMRs and predict measurements for remaining CMRs of the configured set of CMRs. In other words, the UE may measuring one or more CMRs and predict measurements for remaining CMRs. Accordingly, the UE may transmit a report (e.g., a CSI report) that includes predicted measurements, actual measurements, or both predicted measurements and actual measurements. Additionally, the UE may indicate, to the network entity, whether the report includes predicted measurements, actual measurements, or both predicted measurements and actual measurements. That is, together with a reporting payload for the report, UE may indicate whether the reporting payload is associated with actually measured channel characteristics (e.g., actual measurements) or predicted channel characteristics (e.g., predicted measurements), or both.

In some examples, the UE may report channel characteristics via a CSI report in which the reporting payload may include a single bit or combinatorial index that indicates whether actually measured channel characteristics or predicted channel characteristics are reported. As illustrated in the example of FIG. 4A, the UE may transmit a report 415-a or a report 415-b that each include four RSRP measurement results (e.g., L1-RSRP measurement results) that may be indexed from 1 to 4. Each RSRP measurement may be associated with respective CMRs. For example, each RSRP measurement included in the report 415-a and the report 415-b may be associated with a respective CMR. The RSRP measurement results included in the report 415-a may be predicted measurements. Accordingly, the report 415-a may include a bit 405-a (or a combinatorial index) that indicates the RSRP measurements included in the report 415-a are predicted measurement results. The RSRP measurement results included in the report 415-b may be actual measurements. Accordingly, the report 415-b may include a bit 405-b (or another combinatorial index) that indicates the RSRP measurements included in the report 415-b are actual measurement results.

In some other examples, the UE may report channel characteristics via a CSI report in which the reporting payload includes a bitmap (or combinatorial indices). In such examples, each bit of the bitmap may be associated with a respective reference signal resource (e.g., CMR) addressed in the CSI report and may indicate whether actually measured channel characteristics or predicted channel characteristics are reported for the corresponding reference signal resource. As illustrated in the example of FIG. 4B, the UE may transmit a report 415-c that includes four RSRP measurement results (e.g., L1-RSRP measurement results) that may be indexed from 1 to 4. Each RSRP measurement result may be associated with a respective reference signal resources. For example, each RSRP measurement included in the report 415-c may be associated with a respective CMR. The RSRP measurement with an index of 1 (e.g., RSRP #1) and the RSRP measurement with an index of 3 (e.g., RSRP #3) may correspond to predicted measurement results. Accordingly a bit 405-c associated with RSRP #1 and a bit 405-e associated with RSRP #3 may each have a value set to 0. Additionally, the RSRP measurement with an index of 2 (e.g., RSRP #2) and the RSRP measurement with an index of 4 (e.g., RSRP #4) may correspond to actual measurement results. Accordingly a bit 405-d associated with RSRP #2 and a bit 405-f associated with RSRP #4 may each have a value set to 1. In such an example, the bit 405-c and the bit 405-e may indicate that predicted RSRP measurement results (e.g., predicted channel characteristics) are reported for the corresponding CMRs. That is, the bit 405-c and the bit 405-e may indicate that RSRP #1 and RSRP #3 correspond to predicted measurement results. Additionally, in such an example, the bit 405-d and the bit 405-f may indicate that actual RSRP measurement results (e.g., actually measured channel characteristics) are reported for the corresponding CMRs. That is, the bit 405-d and the bit 405-f may indicate that RSRP #1 and RSRP #4 correspond to actual RSRP measurement results.

In some examples, the UE may include a predicted measurement or an actual measurement based on a triggering event. An event triggering the UE to report actually measured channel characteristics (e.g., an actual measurement) for a reference signal resource may be hardcoded at the UE (e.g., based on a predefinition), based on a configuration from the network entity (e.g., a gNB configuration), or based on a recommendation from the UE (e.g., a UE recommendation), or any combination thereof. An example of a triggering event (e.g., an event triggering the UE to report actually measured channel characteristics) may include a predicted measurement (e.g., a predicted L1-RSRP or L1-SINR) for a CMR regarding a previous (e.g., a relatively recent) reporting occasion satisfying a trigger condition. In some examples, the predicted measurement may satisfy the trigger condition if a confidence level associated with the predicted measurement satisfies (e.g., falls below) a confidence level threshold. In some examples, the confidence level threshold may correspond to (e.g., include, be defined in terms of) a percentage or standard deviation (e.g., in dBm) of a predicted measurement. In some examples, the confidence level threshold may be hardcoded at the UE (e.g., based on predefinition), based on a configuration from the network entity (e.g., a gNB configuration), or based on a recommendation from the UE (e.g., a UE recommendation), or any combination thereof.

Although the examples of FIGS. 4A and 4B illustrate the reported channel characteristics as RSRP measurement results, the UE may report other types of channel characteristics, such as SINR measurement results (e.g., L1-SINR measurement results), RIs, PMIs, or CQIs, among other examples of channel characteristics. Additionally, although the examples of FIGS. 4A and 4B illustrate four RSRP measurements included in each of the reports 415, the UE may report more than four measurements or less than four measurements. In some examples, the UE may include an indication (e.g., the bitmap or combinatorial index) of whether reported channel characteristics are predicted channel characteristics or actually measured channel characteristics based on a request from the network entity. In some examples, indicating whether reported channel characteristics are predicted channel characteristics or actually measured channel characteristics may lead to increased performance for beam management, among other possible benefits.

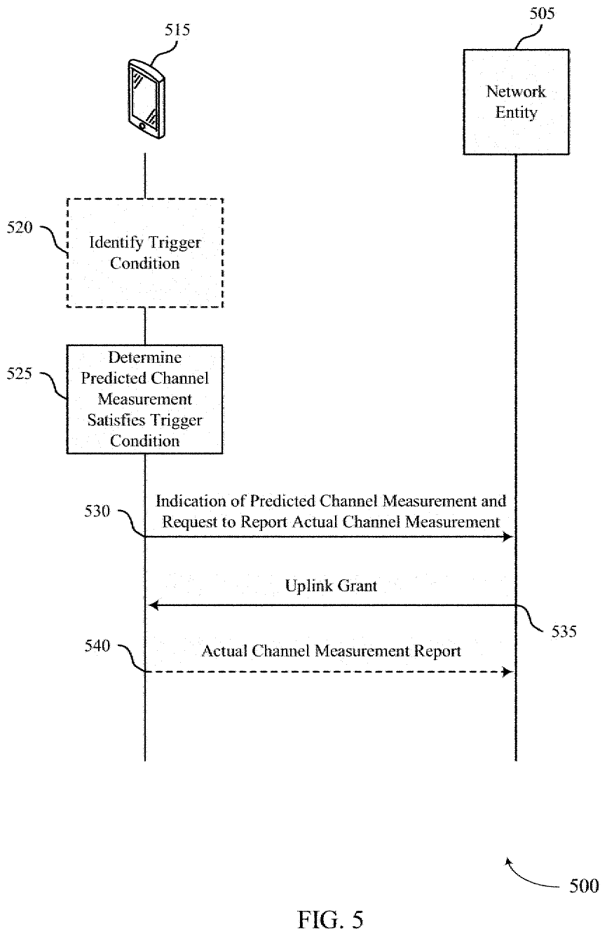

FIG. 5 illustrates an example of a process flow 500 that supports device triggered beam measurement reporting in accordance with one or more aspects of the present disclosure. The process flow 500 may implement or be implemented to realize or facilitate aspects of the wireless communications system 100, the wireless communications system 200, the reporting scheme 300, and the report formats 400. For example, the process flow 500 may be implemented at a UE 515 and a network entity 505, which may be examples of the corresponding devices illustrated by and described with reference to FIGS. 1 through 3, 4A, and 4B. The operations performed at the UE 515 and the network entity 505 may support improvements to communications between the UE 515 and the network entity 505, among other benefits. In the following description of the process flow 500, the operations performed at the UE 515 and the network entity 505 may occur in a different order than the example order shown. Additionally, the operations performed at the UE 515 and the network entity 505 may be performed at different times. Some operations may be combined and some operations may be omitted. The UE 515 and the network entity 505 may support a framework for reporting actual channel measurements associated with time-domain (or spatial-domain) beam predictions based on a triggering event, such as a predicted measurement satisfying a trigger condition.

At 525, the UE 515 may determine that a predicted channel measurement associated with a reference signal resource satisfies a trigger condition. The trigger condition may be an example of a trigger condition illustrated by and described with reference to FIGS. 2, 3, 4A, and 4B. For example, the trigger condition may correspond to a confidence level threshold. In such an example, the predicted measurement may satisfy the trigger condition based on a confidence level associated with the predicted measurement satisfying the confidence level threshold. The trigger condition may be identified at the UE 515.

For example, at 520, the UE 515 may identify the trigger condition. In some examples, the UE 515 may identify the trigger condition based on an indication received from the network entity 505. For example, the network entity 505 may indicate the trigger condition or a rule for determining the trigger condition to the UE 515. In such an example, the indicated trigger condition may be based on a recommendation from the UE 515. In some other examples, the UE 515 may identify the trigger condition based on a configuration at the UE 515. For example, the UE 515 may be hardcoded with the trigger condition or a rule for determining the trigger condition. In some examples, the UE 515 may transmit an indication of the trigger condition to the network entity 505.

At 530, the UE 515 may transmit a first report that includes an indication of the predicted channel measurement and a request to report an actual channel measurement associated with the predicted channel measurement. That is, the first report may include a request to transmit a second report that indicates the actual channel measurement associated with the predicted channel measurement. In some examples, the UE 515 may request to transmit the second report based on the predicted channel measurement satisfying the trigger condition.

At 535, the UE 515 may receive an uplink grant from the network entity 505 in response to the request. The uplink grant may be an example of an uplink grant illustrated by and described with reference to FIG. 2. For example, the uplink grant may indicate at least an uplink resource to transmit the second report.

At 540, the UE 515 may transmit the second report that indicates the actual channel measurement to the network entity 505. The UE 515 may transmit the second report via the uplink resource. The second report may be an example of a second report illustrated by and discussed with reference to FIGS. 2 and 3. For example, the second report may be an example of a CSI report, such as an aperiodic CSI report.

In some examples, the actual channel measurement may be of a reference signal transmitted from the network entity 505. For example, the UE 515 may receive a reference signal transmitted using a second reference signal resource from the network entity 505. The second reference signal resource may be associated with the reference signal resource. For example, the reference signal resource may be a virtual resource and the second reference signal resource may be a CMR linked to (e.g., associated with) the virtual resource. In some examples, requesting to report an actual measurement for a predicted measurement based on the predicted measurement satisfying a triggering condition may lead to increased performance for beam management, among other possible benefits.

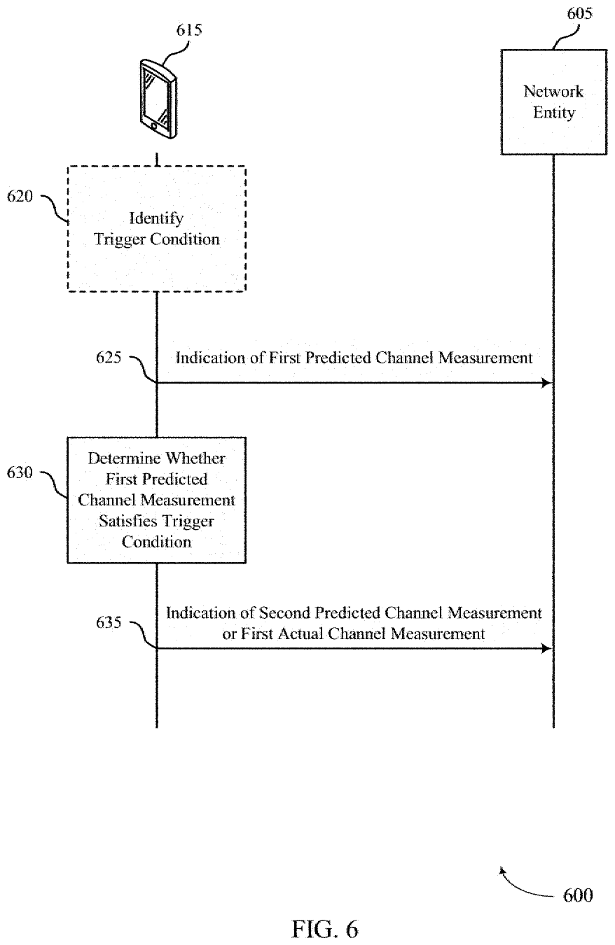

FIG. 6 illustrates an example of a process flow 600 that supports device triggered beam measurement reporting in accordance with one or more aspects of the present disclosure. The process flow 600 may implement or be implemented to realize or facilitate aspects of the wireless communications system 100, the wireless communications system 200, the reporting scheme 300, the report formats 400, and the process flow 500. For example, the process flow 600 may be implemented at a UE 615 and a network entity 605, which may be examples of the corresponding devices illustrated by and described with reference to FIGS. 1 through 3, 4A, 4B, and 5. The operations performed at the UE 615 and the network entity 605 may support improvements to communications between the UE 615 and the network entity 605, among other benefits. In the following description of the process flow 600, the operations performed at the UE 615 and the network entity 605 may occur in a different order than the example order shown. Additionally, the operations performed at the UE 615 and the network entity 605 may be performed at different times. Some operations may be combined and some operations may be omitted. The UE 615 and the network entity 605 may support a framework for indicating whether reported channel characteristics are predicted channel characteristics or actually measured channel characteristics.

At 625, the UE 615 may transmit an indication of a first predicted channel measurement to the network entity 605. For example, the UE 615 may transmit a first report that indicates at least the first predicted channel measurement, which may be associated with a first reference signal resource of a set of reference signal resources.

At 630, the UE 615 may determine whether the first predicted channel measurement satisfies a trigger condition. The trigger condition may be an example of a trigger condition illustrated by and described with reference to FIGS. 2, 3, and 4A, and 4B. For example, the trigger condition may correspond to a confidence level threshold. In such an example, the predicted measurement may satisfy the trigger condition based on a confidence level associated with the predicted measurement satisfying the confidence level threshold. The trigger condition may be identified at the UE 615.

For example, at 620, the UE 615 may identify the trigger condition based on an indication received from the network entity 605. For example, the network entity 605 may indicate the trigger condition or a rule for determining the trigger condition to the UE 615. In such an example, the indicated trigger condition may be based on a recommendation from the UE 615. In some other examples, the UE 615 may identify the trigger condition based on a configuration at the UE 615. For example, the UE 615 may be hardcoded with the trigger condition or a rule for determining the trigger condition. In some examples, the UE 615 may transmit an indication of the trigger condition to the network entity 605.

At 635, the UE 615 may transmit an indication of a second predicted channel measurement associated with the first predicted channel measurement or a first actual channel measurement associated with the first predicted channel measurement. For example, the UE 615 may transmit a second report to the network entity 605 that indicates a channel measurement associated with the first reference signal resource. The second report may also indicate that the first channel measurement includes the second predicted channel measurement or the first actual channel measurement based on whether the first predicted channel measurement satisfies the trigger condition.

For example, the UE 615 may determine (e.g., at 630) that the first predicted channel measurement fails to satisfy the trigger condition. In such an example, based on the first predicted channel measurement failing to satisfy the trigger condition, the UE 615 may transmit an indication of an actual channel measurement to the network entity 605 (e.g., at 635). Accordingly, the second report may indicate that the first channel measurement includes the first actual channel measurement.

In some other examples, the UE 615 may determine (e.g., at 630) that the first predicted channel measurement satisfies the trigger condition. In such an example, based on the first predicted channel measurement satisfying the trigger condition, the UE 615 may transmit an indication of another predicted channel measurement to the network entity 605 (e.g., at 635). Accordingly, the second report may indicate that the first channel measurement includes the second predicted channel measurement. In some examples, indicating whether reported channel characteristics are predicted channel characteristics or actually measured channel characteristics may lead to improved performance for CSI reporting, among other possible benefits.

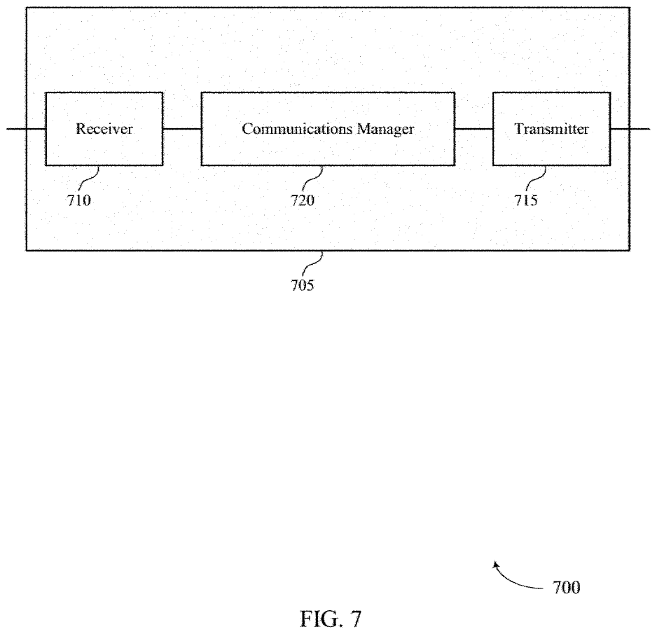

FIG. 7 illustrates a diagram 700 of a device 705 that supports device triggered beam measurement reporting in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to device triggered beam measurement reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to device triggered beam measurement reporting). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of device triggered beam measurement reporting as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. For example, the communications manager 720 may be configured as or otherwise support a means for transmitting, to a network entity, a first report that indicates a predicted channel measurement associated with a reference signal resource. The communications manager 720 may be configured as or otherwise support a means for determining that the predicted channel measurement satisfies a trigger condition, where the first report indicates a request to transmit a second report that indicates an actual channel measurement associated with the predicted channel measurement based on the predicted channel measurement satisfying the trigger condition. The communications manager 720 may be configured as or otherwise support a means for receiving, from the network entity in response to the request, a grant of at least an uplink resource to transmit the second report.

Additionally, or alternatively, the communications manager 720 may support wireless communication at a UE (e.g., the device 705) in accordance with examples as disclosed herein. For example, the communications manager 720 may be configured as or otherwise support a means for transmitting, to a network entity, a first report that indicates at least a first predicted channel measurement associated with a first reference signal resource of a set of reference signal resources. The communications manager 720 may be configured as or otherwise support a means for determining whether the first predicted channel measurement satisfies a trigger condition. The communications manager 720 may be configured as or otherwise support a means for transmitting, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

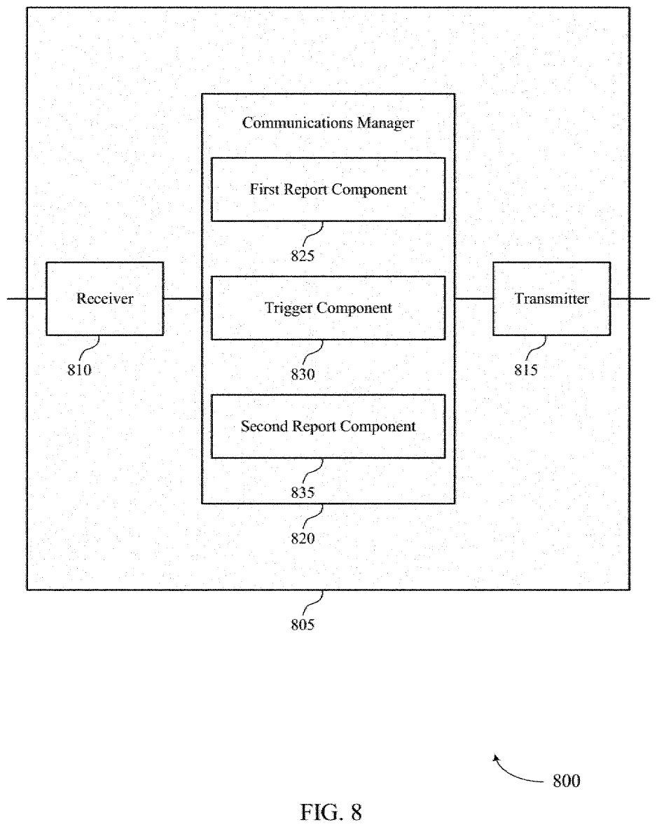

FIG. 8 illustrates a diagram 800 of a device 805 that supports device triggered beam measurement reporting in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to device triggered beam measurement reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to device triggered beam measurement reporting). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of device triggered beam measurement reporting as described herein. For example, the communications manager 820 may include a first report component 825, a trigger component 830, a second report component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE (e.g., the device 805) in accordance with examples as disclosed herein. The first report component 825 may be configured as or otherwise support a means for transmitting, to a network entity, a first report that indicates a predicted channel measurement associated with a reference signal resource. The trigger component 830 may be configured as or otherwise support a means for determining that the predicted channel measurement satisfies a trigger condition, where the first report indicates a request to transmit a second report that indicates an actual channel measurement associated with the predicted channel measurement based on the predicted channel measurement satisfying the trigger condition. The second report component 835 may be configured as or otherwise support a means for receiving, from the network entity in response to the request, a grant of at least an uplink resource to transmit the second report.

Additionally, or alternatively, the communications manager 820 may support wireless communication at a UE (e.g., the device 805) in accordance with examples as disclosed herein. The first report component 825 may be configured as or otherwise support a means for transmitting, to a network entity, a first report that indicates at least a first predicted channel measurement associated with a first reference signal resource of a set of reference signal resources. The trigger component 830 may be configured as or otherwise support a means for determining whether the first predicted channel measurement satisfies a trigger condition. The second report component 835 may be configured as or otherwise support a means for transmitting, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

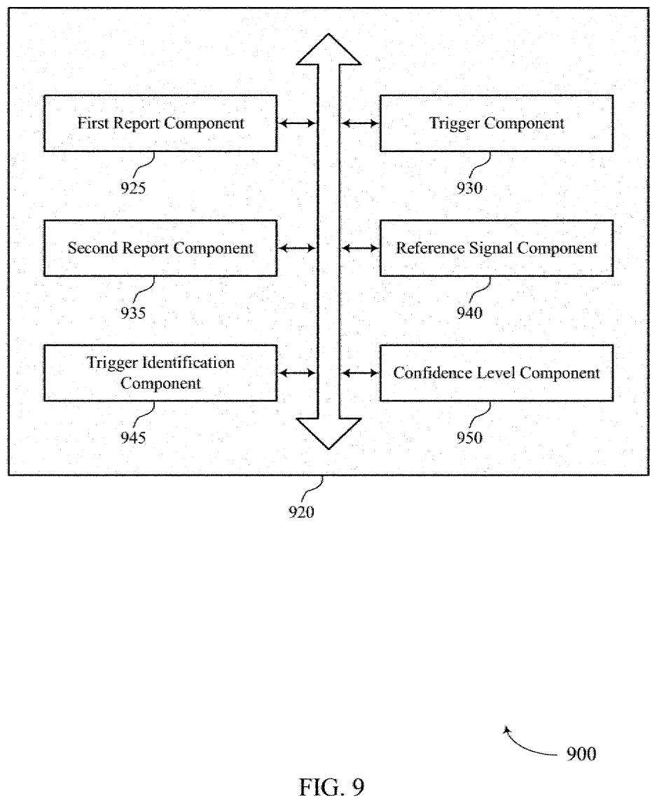

FIG. 9 illustrates a diagram 900 of a communications manager 920 that supports device triggered beam measurement reporting in accordance with one or more aspects of the present disclosure. The communications manager 920 may be an example of aspects of a communications manager 720, a communications manager 820, or both, as described herein. The communications manager 920, or various components thereof, may be an example of means for performing various aspects of device triggered beam measurement reporting as described herein. For example, the communications manager 920 may include a first report component 925, a trigger component 930, a second report component 935, a reference signal component 940, a trigger identification component 945, a confidence level component 950, or any combination thereof. Each of these components may communicate, directly or indirectly, with one another (e.g., via one or more buses).

The communications manager 920 may support wireless communication at a UE in accordance with examples as disclosed herein. The first report component 925 may be configured as or otherwise support a means for transmitting, to a network entity, a first report that indicates a predicted channel measurement associated with a reference signal resource. The trigger component 930 may be configured as or otherwise support a means for determining that the predicted channel measurement satisfies a trigger condition, where the first report indicates a request to transmit a second report that indicates an actual channel measurement associated with the predicted channel measurement based on the predicted channel measurement satisfying the trigger condition. The second report component 935 may be configured as or otherwise support a means for receiving, from the network entity in response to the request, a grant of at least an uplink resource to transmit the second report.

In some examples, to support transmitting the first report, the first report component 925 may be configured as or otherwise support a means for transmitting the first report during a first duration, where the predicted channel measurement is associated with a second duration subsequent to the first duration.

In some examples, the reference signal component 940 may be configured as or otherwise support a means for receiving, from the network entity, a reference signal transmitted using a second reference signal resource associated with the reference signal resource. In some examples, the second report component 935 may be configured as or otherwise support a means for transmitting, to the network entity using the uplink resource, the second report that indicates the actual channel measurement associated with the predicted channel measurement, where the actual channel measurement is of the reference signal. In some examples, the reference signal resource includes a virtual resource. In some examples, the second reference signal resource includes a CMR.

In some examples, the trigger identification component 945 may be configured as or otherwise support a means for identifying the trigger condition, where determining that the predicted channel measurement satisfies the trigger condition is based on identifying the trigger condition. In some examples, the trigger identification component 945 may be configured as or otherwise support a means for receiving, from the network entity, an indication of the trigger condition, where identifying the trigger condition is based on the received indication. In some examples, the trigger identification component 945 may be configured as or otherwise support a means for transmitting, to the network entity, an indication of the identified trigger condition.

In some examples, to support determining that the predicted channel measurement satisfies the trigger condition, the trigger component 930 may be configured as or otherwise support a means for determining that a difference between the predicted channel measurement and a second predicted channel measurement associated with a second reference signal resource satisfies a threshold, where the predicted channel measurement and the second predicted channel measurement are associated with a same duration.

In some examples, the first report indicates a set of multiple actual channel measurements that are associated with a set of multiple reference signal resources include the second reference signal resource. In some examples, the second reference signal resource corresponds to a strongest channel measurement of the set of multiple actual channel measurements.

In some examples, the second reference signal resource corresponds to a TCI state associated with a previously scheduled PDCCH transmission or a previously scheduled PDSCH transmission. In some examples, to support determining that the predicted channel measurement satisfies the trigger condition, the confidence level component 950 may be configured as or otherwise support a means for determining that a confidence level associated with the predicted channel measurement satisfies a threshold.

In some examples, the first report includes a bitmap or a combinatorial index that indicates the request. In some examples, the first report includes a periodic CSI report and the second report includes an aperiodic CSI report. In some examples, the reference signal resource includes a CMR.

Additionally, or alternatively, the communications manager 920 may support wireless communication at a UE in accordance with examples as disclosed herein. In some examples, the first report component 925 may be configured as or otherwise support a means for transmitting, to a network entity, a first report that indicates at least a first predicted channel measurement associated with a first reference signal resource of a set of reference signal resources. In some examples, the trigger component 930 may be configured as or otherwise support a means for determining whether the first predicted channel measurement satisfies a trigger condition. In some examples, the second report component 935 may be configured as or otherwise support a means for transmitting, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

In some examples, to support determining whether the first predicted channel measurement satisfies the trigger condition, the trigger component 930 may be configured as or otherwise support a means for determining that the first predicted channel measurement fails to satisfy the trigger condition, where the second report indicates that the first channel measurement includes the first actual channel measurement based on the first predicted channel measurement failing to satisfy the trigger condition.

In some examples, to support determining whether the first predicted channel measurement satisfies the trigger condition, the trigger component 930 may be configured as or otherwise support a means for determining that the first predicted channel measurement satisfies the trigger condition, where the second report indicates that the first channel measurement includes the second predicted channel measurement based on the first predicted channel measurement satisfying the trigger condition.

In some examples, to support transmitting the second report, the second report component 935 may be configured as or otherwise support a means for transmitting a bit that indicates the first channel measurement includes predicted channel measurements or actual channel measurements.

In some examples, to support transmitting the second report, the second report component 935 may be configured as or otherwise support a means for transmitting a first indication that the first channel measurement includes the second predicted channel measurement or the first actual channel measurement. In some examples, to support transmitting the second report, the second report component 935 may be configured as or otherwise support a means for transmitting a second indication that a second channel measurement includes a third predicted channel measurement or a second actual channel measurement.

In some examples, the first indication includes a first bit or a first combinatorial index associated with the first channel measurement and the second indication includes a second bit or a second combinatorial index associated with the second channel measurement.

In some examples, to support determining whether the first predicted channel measurement satisfies the trigger condition, the confidence level component 950 may be configured as or otherwise support a means for determining that a confidence level associated with the first predicted channel measurement satisfies a threshold.

In some examples, the trigger identification component 945 may be configured as or otherwise support a means for identifying the trigger condition, where determining that the first predicted channel measurement satisfies the trigger condition is based on identifying the trigger condition.

In some examples, the trigger identification component 945 may be configured as or otherwise support a means for receiving, from the network entity, an indication of the trigger condition, where identifying the trigger condition is based on the received indication.

In some examples, the trigger identification component 945 may be configured as or otherwise support a means for transmitting, to the network entity, an indication of the identified trigger condition.

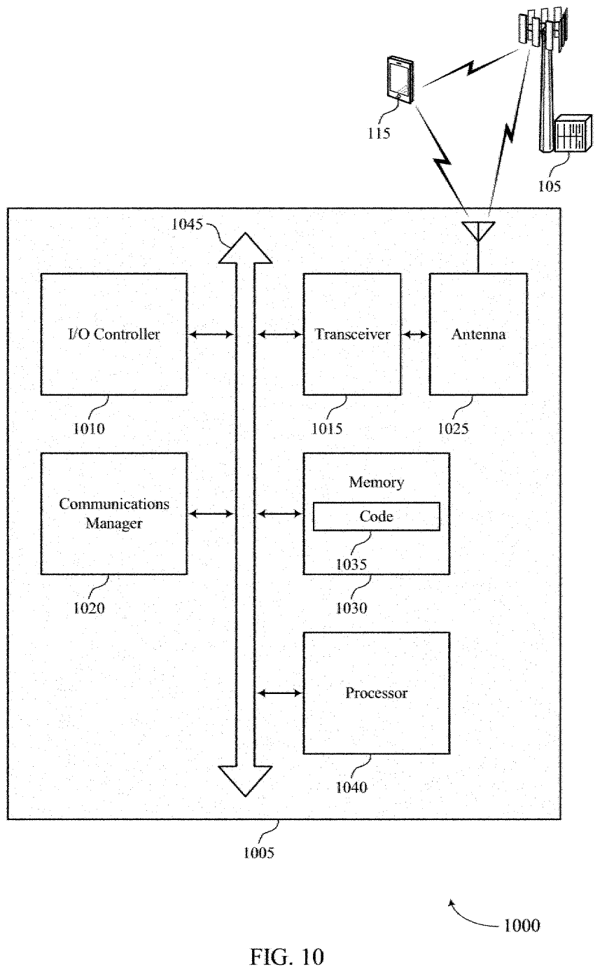

FIG. 10 illustrates a diagram of a system 1000 including a device 1005 that supports device triggered beam measurement reporting in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting device triggered beam measurement reporting). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE (e.g., the device 1005) in accordance with examples as disclosed herein. For example, the communications manager 1020 may be configured as or otherwise support a means for transmitting, to a network entity, a first report that indicates a predicted channel measurement associated with a reference signal resource. The communications manager 1020 may be configured as or otherwise support a means for determining that the predicted channel measurement satisfies a trigger condition, where the first report indicates a request to transmit a second report that indicates an actual channel measurement associated with the predicted channel measurement based on the predicted channel measurement satisfying the trigger condition. The communications manager 1020 may be configured as or otherwise support a means for receiving, from the network entity in response to the request, a grant of at least an uplink resource to transmit the second report.

Additionally, or alternatively, the communications manager 1020 may support wireless communication at a UE (e.g., the device 1005) in accordance with examples as disclosed herein. For example, the communications manager 1020 may be configured as or otherwise support a means for transmitting, to a network entity, a first report that indicates at least a first predicted channel measurement associated with a first reference signal resource of a set of reference signal resources. The communications manager 1020 may be configured as or otherwise support a means for determining whether the first predicted channel measurement satisfies a trigger condition. The communications manager 1020 may be configured as or otherwise support a means for transmitting, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition.

By including or configuring the communications manager 1020 in accordance with examples as described herein, the device 1005 may support techniques for improved communication reliability, reduced latency, improved user experience related to reduced processing, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of device triggered beam measurement reporting as described herein, or the processor 1040 and the memory 1030 may be otherwise configured to perform or support such operations.

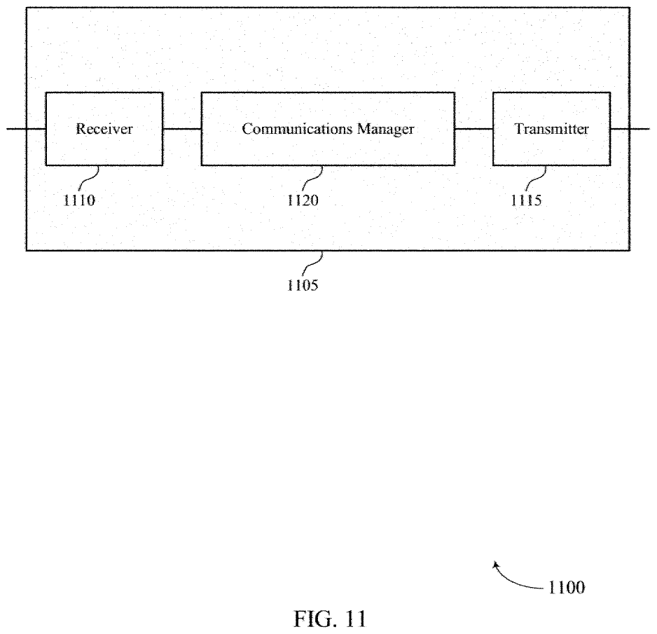

FIG. 11 illustrates a diagram 1100 of a device 1105 that supports device triggered beam measurement reporting in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of device triggered beam measurement reporting as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. For example, the communications manager 1120 may be configured as or otherwise support a means for obtaining a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition. The communications manager 1120 may be configured as or otherwise support a means for outputting, in response to the request, a grant of at least an uplink resource to being used to transmit the second report. The communications manager 1120 may be configured as or otherwise support a means for obtaining the second report that indicates the actual channel measurement associated with the predicted channel measurement based on outputting the grant.

Additionally, or alternatively, the communications manager 1120 may support wireless communication at a network entity (e.g., the device 1105) in accordance with examples as disclosed herein. For example, the communications manager 1120 may be configured as or otherwise support a means for obtaining a first report that indicates at least a first predicted channel measurement associated with a reference signal resource of a set of reference signal resources. The communications manager 1120 may be configured as or otherwise support a means for obtaining a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources.

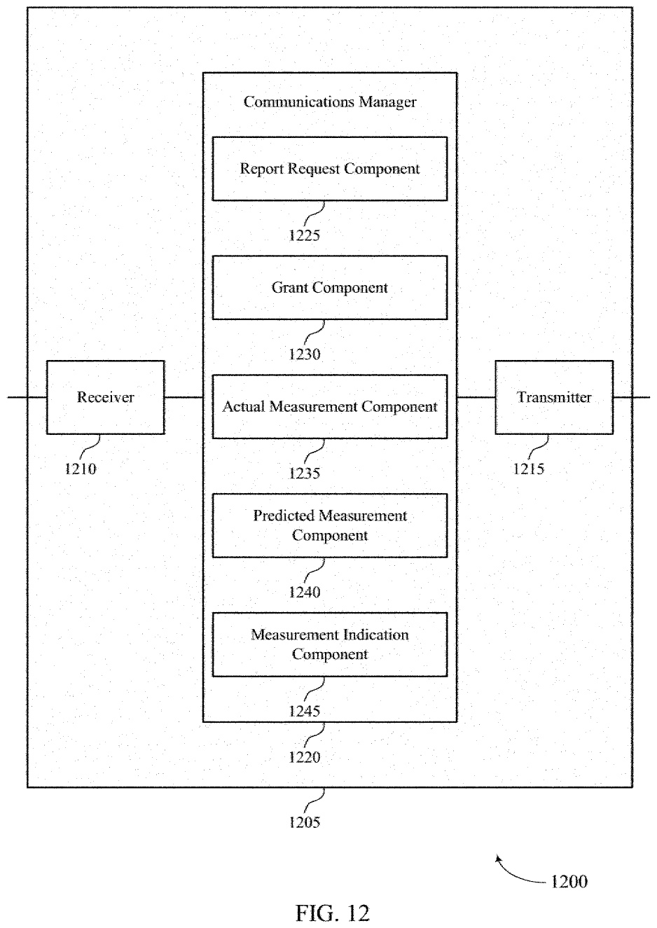

FIG. 12 illustrates a diagram 1200 of a device 1205 that supports device triggered beam measurement reporting in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of device triggered beam measurement reporting as described herein. For example, the communications manager 1220 may include a report request component 1225, a grant component 1230, an actual measurement component 1235, a predicted measurement component 1240, a measurement indication component 1245, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., the device 1205) in accordance with examples as disclosed herein. The report request component 1225 may be configured as or otherwise support a means for obtaining a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition. The grant component 1230 may be configured as or otherwise support a means for outputting, in response to the request, a grant of at least an uplink resource to be used to transmit the second report. The actual measurement component 1235 may be configured as or otherwise support a means for obtaining the second report that indicates the actual channel measurement associated with the predicted channel measurement based on outputting the grant.

Additionally, or alternatively, the communications manager 1220 may support wireless communication at a network entity (e.g., the device 1205) in accordance with examples as disclosed herein. The predicted measurement component 1240 may be configured as or otherwise support a means for obtaining a first report that indicates at least a first predicted channel measurement associated with a reference signal resource of a set of reference signal resources. The measurement indication component 1245 may be configured as or otherwise support a means for obtaining a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

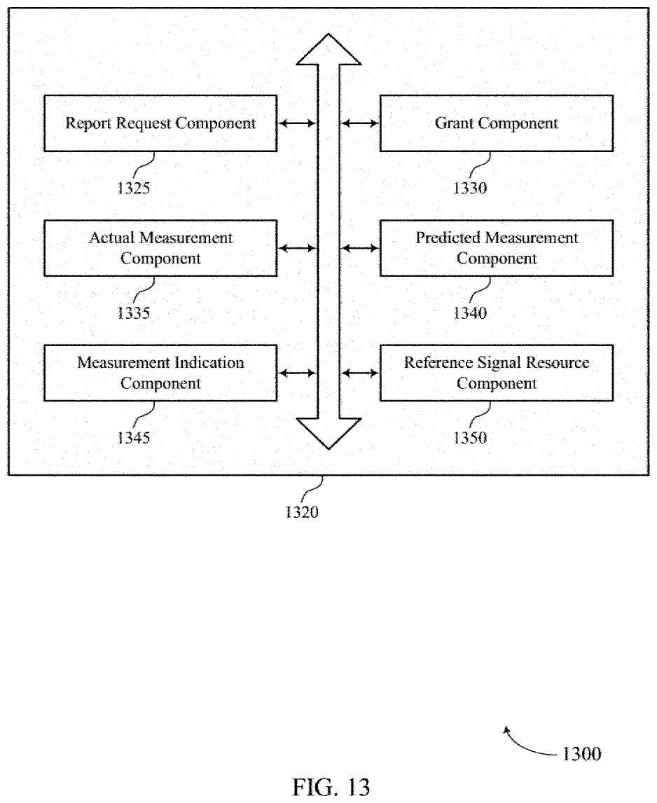

FIG. 13 illustrates a diagram 1300 of a communications manager 1320 that supports device triggered beam measurement reporting in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of device triggered beam measurement reporting as described herein. For example, the communications manager 1320 may include a report request component 1325, a grant component 1330, an actual measurement component 1335, a predicted measurement component 1340, a measurement indication component 1345, a reference signal resource component 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The report request component 1325 may be configured as or otherwise support a means for obtaining a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition. The grant component 1330 may be configured as or otherwise support a means for outputting, in response to the request, a grant of at least an uplink resource to be used to transmit the second report. The actual measurement component 1335 may be configured as or otherwise support a means for obtaining the second report that indicates the actual channel measurement associated with the predicted channel measurement based on outputting the grant.

In some examples, the predicted channel measurement is associated with a duration, and the reference signal resource component 1350 may be configured as or otherwise support a means for outputting a reference signal using a second reference signal resource associated with the reference signal resource, where the actual channel measurement is of the reference signal.

In some examples, the reference signal resource includes a virtual resource. In some examples, the second reference signal resource includes a CMR. In some examples, the first report includes a bitmap or a combinatorial index that indicates the request.

Additionally, or alternatively, the communications manager 1320 may support wireless communication at a network entity in accordance with examples as disclosed herein. The predicted measurement component 1340 may be configured as or otherwise support a means for obtaining a first report that indicates at least a first predicted channel measurement associated with a reference signal resource of a set of reference signal resources. The measurement indication component 1345 may be configured as or otherwise support a means for obtaining a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

In some examples, to support transmitting the second report, the predicted measurement component 1340 may be configured as or otherwise support a means for obtaining one or more bits that indicate the channel measurement includes the second predicted channel measurement or the first actual channel measurement.

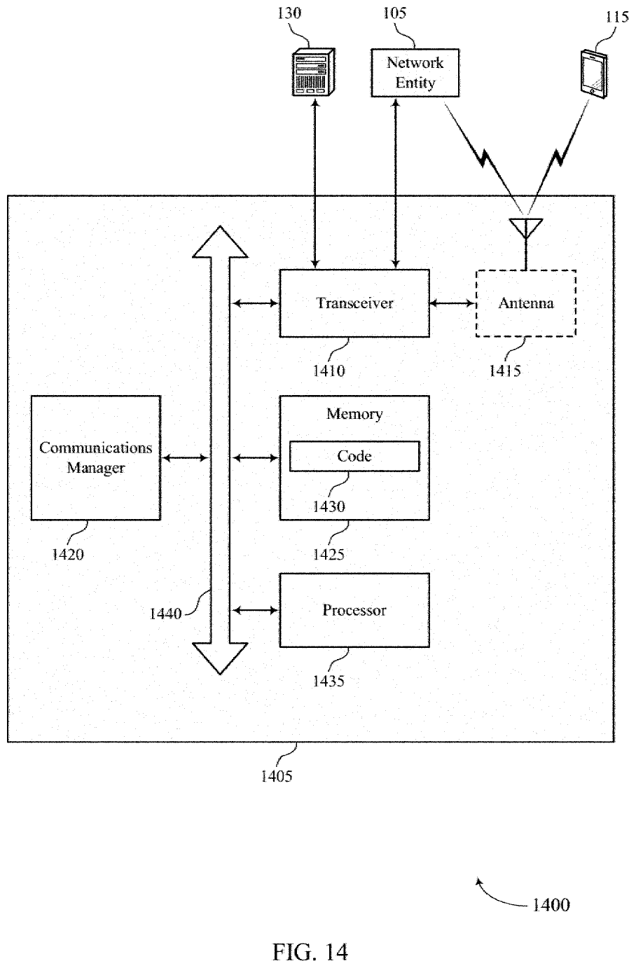

FIG. 14 illustrates a diagram of a system 1400 including a device 1405 that supports device triggered beam measurement reporting in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting device triggered beam measurement reporting). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity (e.g., the device 1405) in accordance with examples as disclosed herein. For example, the communications manager 1420 may be configured as or otherwise support a means for obtaining a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition. The communications manager 1420 may be configured as or otherwise support a means for outputting, in response to the request, a grant of at least an uplink resource to being used to transmit the second report. The communications manager 1420 may be configured as or otherwise support a means for obtaining the second report that indicates the actual channel measurement associated with the predicted channel measurement based on outputting the grant.

Additionally, or alternatively, the communications manager 1420 may support wireless communication at a network entity (e.g., the device 1405) in accordance with examples as disclosed herein. For example, the communications manager 1420 may be configured as or otherwise support a means for obtaining a first report that indicates at least a first predicted channel measurement associated with a reference signal resource of a set of reference signal resources. The communications manager 1420 may be configured as or otherwise support a means for obtaining a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition.

By including or configuring the communications manager 1420 in accordance with examples as described herein, the device 1405 may support techniques for improved communication reliability, reduced latency, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of device triggered beam measurement reporting as described herein, or the processor 1435 and the memory 1425 may be otherwise configured to perform or support such operations.

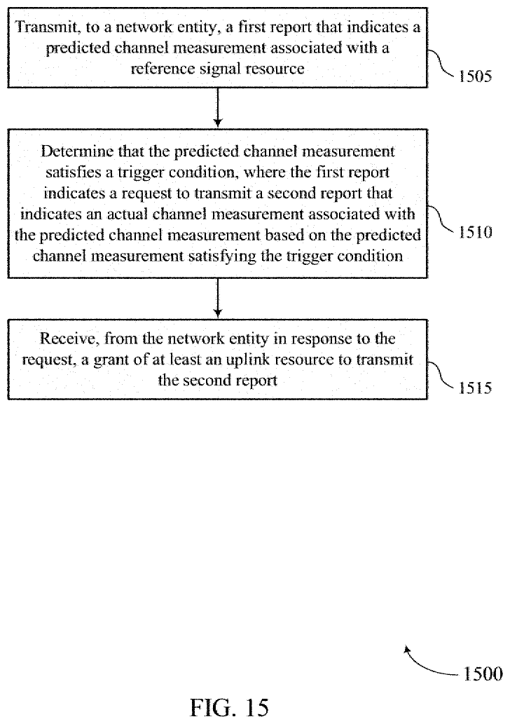

FIG. 15 illustrates a flowchart showing a method 1500 that supports device triggered beam measurement reporting in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting, to a network entity, a first report that indicates a predicted channel measurement associated with a reference signal resource. The operations of 1505 may be performed in accordance with examples as disclosed herein. In some examples, aspects of the operations of 1505 may be performed by a first report component 925 as described with reference to FIG. 9.

At 1510, the method may include determining that the predicted channel measurement satisfies a trigger condition, where the first report indicates a request to transmit a second report that indicates an actual channel measurement associated with the predicted channel measurement based on the predicted channel measurement satisfying the trigger condition. The operations of 1510 may be performed in accordance with examples as disclosed herein. In some examples, aspects of the operations of 1510 may be performed by a trigger component 930 as described with reference to FIG. 9.

At 1515, the method may include receiving, from the network entity in response to the request, a grant of at least an uplink resource to transmit the second report. The operations of 1515 may be performed in accordance with examples as disclosed herein. In some examples, aspects of the operations of 1515 may be performed by a second report component 935 as described with reference to FIG. 9.

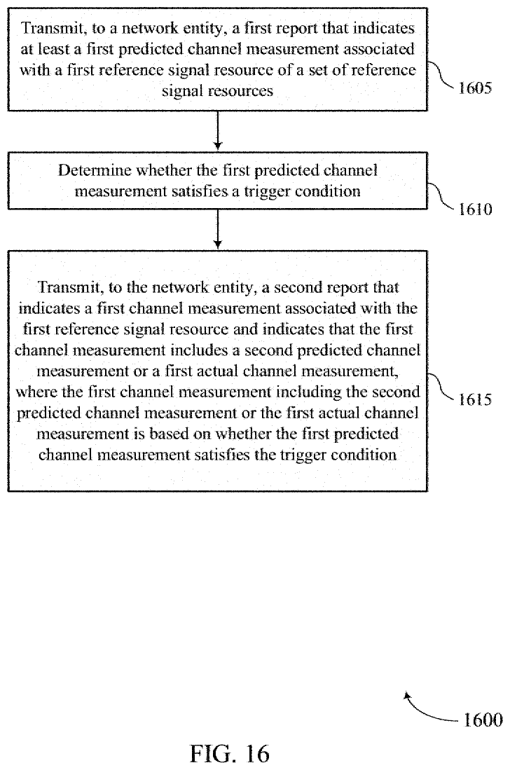

FIG. 16 illustrates a flowchart showing a method 1600 that supports device triggered beam measurement reporting in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting, to a network entity, a first report that indicates at least a first predicted channel measurement associated with a first reference signal resource of a set of reference signal resources. The operations of 1605 may be performed in accordance with examples as disclosed herein. In some examples, aspects of the operations of 1605 may be performed by a first report component 925 as described with reference to FIG. 9.

At 1610, the method may include determining whether the first predicted channel measurement satisfies a trigger condition. The operations of 1610 may be performed in accordance with examples as disclosed herein. In some examples, aspects of the operations of 1610 may be performed by a trigger component 930 as described with reference to FIG. 9.

At 1615, the method may include transmitting, to the network entity, a second report that indicates a first channel measurement associated with the first reference signal resource and indicates that the first channel measurement includes a second predicted channel measurement or a first actual channel measurement, where the first channel measurement including the second predicted channel measurement or the first actual channel measurement is based on whether the first predicted channel measurement satisfies the trigger condition. The operations of 1615 may be performed in accordance with examples as disclosed herein. In some examples, aspects of the operations of 1615 may be performed by a second report component 935 as described with reference to FIG. 9.

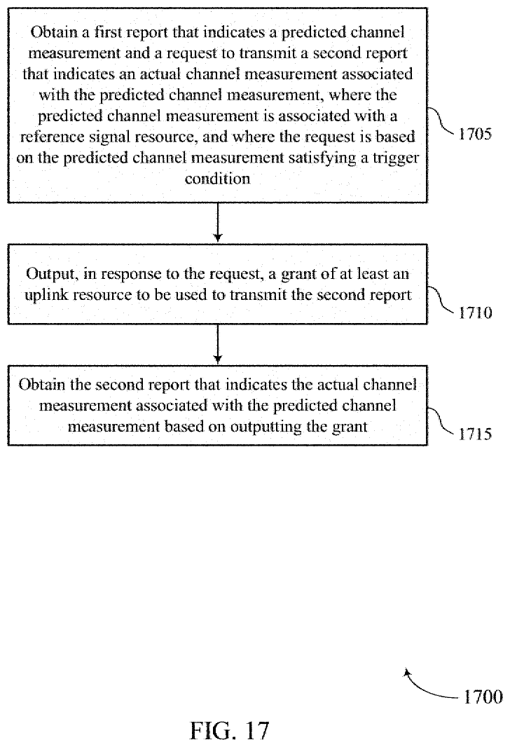

FIG. 17 illustrates a flowchart showing a method 1700 that supports device triggered beam measurement reporting in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include obtaining a first report that indicates a predicted channel measurement and a request to transmit a second report that indicates an actual channel measurement associated with the predicted channel measurement, where the predicted channel measurement is associated with a reference signal resource, and where the request is based on the predicted channel measurement satisfying a trigger condition. The operations of 1705 may be performed in accordance with examples as disclosed herein. In some examples, aspects of the operations of 1705 may be performed by a report request component 1325 as described with reference to FIG. 13.

At 1710, the method may include outputting, in response to the request, a grant of at least an uplink resource to be used to transmit the second report. The operations of 1710 may be performed in accordance with examples as disclosed herein. In some examples, aspects of the operations of 1710 may be performed by a grant component 1330 as described with reference to FIG. 13.

At 1715, the method may include obtaining the second report that indicates the actual channel measurement associated with the predicted channel measurement based on outputting the grant. The operations of 1715 may be performed in accordance with examples as disclosed herein. In some examples, aspects of the operations of 1715 may be performed by an actual measurement component 1335 as described with reference to FIG. 13.

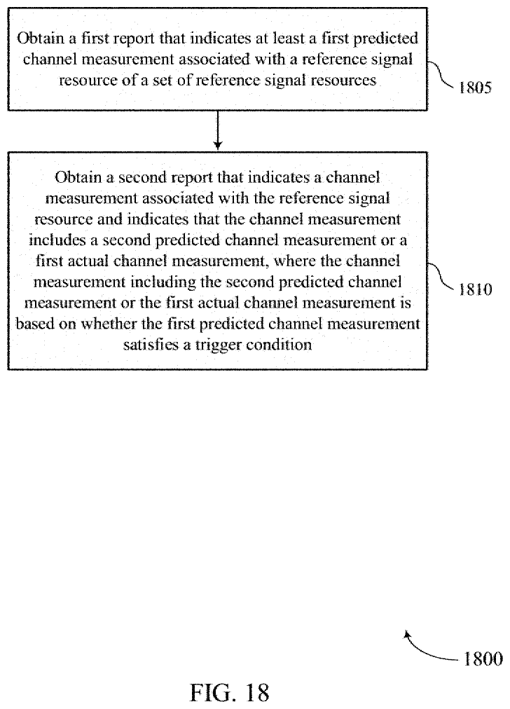

FIG. 18 illustrates a flowchart showing a method 1800 that supports device triggered beam measurement reporting in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include obtaining a first report that indicates at least a first predicted channel measurement associated with a reference signal resource of a set of reference signal resources. The operations of 1805 may be performed in accordance with examples as disclosed herein. In some examples, aspects of the operations of 1805 may be performed by a predicted measurement component 1340 as described with reference to FIG. 13.

At 1810, the method may include obtaining a second report that indicates a channel measurement associated with the reference signal resource and indicates that the channel measurement includes a second predicted channel measurement or a first actual channel measurement, where the channel measurement including the second predicted channel measurement or the first actual channel measurement is based on whether the first predicted channel measurement satisfies a trigger condition. The operations of 1810 may be performed in accordance with examples as disclosed herein. In some examples, aspects of the operations of 1810 may be performed by a measurement indication component 1345 as described with reference to FIG. 13.

The following provides an overview of aspects of the present disclosure:

Aspect 1: A method for wireless communication at a UE, comprising: transmitting, to a network entity, a first report that indicates a predicted channel measurement associated with a reference signal resource; determining that the predicted channel measurement satisfies a trigger condition, wherein the first report indicates a request to transmit a second report that indicates an actual channel measurement associated with the predicted channel measurement based at least in part on the predicted channel measurement satisfying the trigger condition; and receiving, from the network entity in response to the request, a grant of at least an uplink resource to transmit the second report.

Aspect 2: The method of aspect 1, wherein transmitting the first report comprises: transmitting the first report during a first duration, wherein the predicted channel measurement is associated with a second duration subsequent to the first duration.

Aspect 3: The method of any of aspects 1 through 2, further comprising: receiving, from the network entity, a reference signal transmitted using a second reference signal resource associated with the reference signal resource, and transmitting, to the network entity using the uplink resource, the second report that indicates the actual channel measurement associated with the predicted channel measurement, wherein the actual channel measurement is of the reference signal.

Aspect 4: The method of aspect 3, wherein the reference signal resource comprises a virtual resource, and the second reference signal resource comprises a CMR.

Aspect 5: The method of any of aspects 1 through 4, further comprising: identifying the trigger condition, wherein determining that the predicted channel measurement satisfies the trigger condition is based at least in part on identifying the trigger condition.

Aspect 6: The method of aspect 5, further comprising: receiving, from the network entity, an indication of the trigger condition, wherein identifying the trigger condition is based at least in part on the received indication.

Aspect 7: The method of aspect 5, further comprising: transmitting, to the network entity, an indication of the identified trigger condition.

Aspect 8: The method of any of aspects 1 through 7, wherein determining that the predicted channel measurement satisfies the trigger condition comprises: determining that a difference between the predicted channel measurement and a second predicted channel measurement associated with a second reference signal resource satisfies a threshold, wherein the predicted channel measurement and the second predicted channel measurement are associated with a same duration.

Aspect 9: The method of aspect 8, wherein the first report indicates a plurality of actual channel measurements that are associated with a plurality of reference signal resources include the second reference signal resource, and the second reference signal resource corresponds to a strongest channel measurement of the plurality of actual channel measurements.

Aspect 10: The method of aspect 8, wherein the second reference signal resource corresponds to a TCI state associated with a previously scheduled PDCCH transmission or a previously scheduled PDSCH transmission.

Aspect 11: The method of any of aspects 1 through 7, wherein determining that the predicted channel measurement satisfies the trigger condition comprises: determining that a confidence level associated with the predicted channel measurement satisfies a threshold.

Aspect 12: The method of any of aspects 1 through 11, wherein the first report comprises a bitmap or a combinatorial index that indicates the request.

Aspect 13: The method of any of aspects 1 through 12, wherein the first report comprises a periodic CSI report and the second report comprises an aperiodic CSI report.

Aspect 14: The method of any of aspects 1 through 13, wherein the reference signal resource comprises a CMR.

Aspect 15: A method for wireless communication at a UE, comprising: transmitting, to a network entity, a first report that indicates at least a first predicted channel measurement associated with a first reference signal resource of a set of reference signal resources; determining whether the first predicted channel measurement satisfies a trigger condition; and transmitting, to the network entity, a second report that indicates a first channel measurement associated with the first reference signal resource and indicates that the first channel measurement comprises a second predicted channel measurement or a first actual channel measurement, wherein the first channel measurement comprising the second predicted channel measurement or the first actual channel measurement is based at least in part on whether the first predicted channel measurement satisfies the trigger condition.

Aspect 16: The method of aspect 15, wherein determining whether the first predicted channel measurement satisfies the trigger condition comprises: determining that the first predicted channel measurement fails to satisfy the trigger condition, wherein the second report indicates that the first channel measurement comprises the first actual channel measurement based at least in part on the first predicted channel measurement failing to satisfy the trigger condition.

Aspect 17: The method of aspect 15, wherein determining whether the first predicted channel measurement satisfies the trigger condition comprises: determining that the first predicted channel measurement satisfies the trigger condition, wherein the second report indicates that the first channel measurement comprises the second predicted channel measurement based at least in part on the first predicted channel measurement satisfying the trigger condition.

Aspect 18: The method of any of aspects 15 through 17, wherein the second report indicates a set of channel measurements associated with the set of reference signal resources including the first channel measurement, and wherein transmitting the second report comprises: transmitting a bit that indicates the set of channel measurements comprises predicted channel measurements or actual channel measurements.

Aspect 19: The method of any of aspects 15 through 18, wherein the second report indicates the first channel measurement and a second channel measurement associated with a second reference signal resource of the set of reference signal resources, and wherein transmitting the second report comprises: transmitting a first indication that the first channel measurement comprises the second predicted channel measurement or the first actual channel measurement; and transmitting a second indication that the second channel measurement comprises a third predicted channel measurement or a second actual channel measurement.

Aspect 20: The method of aspect 19, wherein the first indication comprises a first bit or a first combinatorial index associated with the first channel measurement and the second indication comprises a second bit or a second combinatorial index associated with the second channel measurement.

Aspect 21: The method of any of aspects 15 through 20, wherein determining whether the first predicted channel measurement satisfies the trigger condition comprises: determining that a confidence level associated with the first predicted channel measurement satisfies a threshold.

Aspect 22: The method of any of aspects 15 through 21, further comprising: identifying the trigger condition, wherein determining that the first predicted channel measurement satisfies the trigger condition is based at least in part on identifying the trigger condition.

Aspect 23: The method of aspect 22, further comprising: receiving, from the network entity, an indication of the trigger condition, wherein identifying the trigger condition is based at least in part on the received indication.

Aspect 24: The method of aspect 22, further comprising: transmitting, to the network entity, an indication of the identified trigger condition.

Aspect 25: A method for wireless communication at a network entity, comprising: obtaining a first report that indicates a predicted channel measurement and a request to transmit a second report that indicates an actual channel measurement associated with the predicted channel measurement, wherein the predicted channel measurement is associated with a reference signal resource, and wherein the request is based at least in part on the predicted channel measurement satisfying a trigger condition; outputting, in response to the request, a grant of at least an uplink resource to be used to transmit the second report; and obtaining the second report that indicates the actual channel measurement associated with the predicted channel measurement based at least in part on outputting the grant.

Aspect 26: The method of aspect 25, wherein the predicted channel measurement is associated with a duration, the method further comprising: outputting a reference signal using a second reference signal resource associated with the reference signal resource, wherein the actual channel measurement is of the reference signal.

Aspect 27: The method of aspect 26, wherein the reference signal resource comprises a virtual resource, and the second reference signal resource comprises a CMR.

Aspect 28: The method of any of aspects 25 through 27, wherein the first report comprises a bitmap or a combinatorial index that indicates the request.

Aspect 29: A method for wireless communication at a network entity, comprising: obtaining a first report that indicates at least a first predicted channel measurement associated with a reference signal resource of a set of reference signal resources; and obtaining a second report that indicates a channel measurement associated with the reference signal resource and indicates that the channel measurement comprises a second predicted channel measurement or a first actual channel measurement, wherein the channel measurement comprising the second predicted channel measurement or the first actual channel measurement is based at least in part on whether the first predicted channel measurement satisfies a trigger condition.

Aspect 30: The method of aspect 29, wherein the second report indicates a set of channel measurements associated with the set of reference signal resources including the channel measurement, and wherein transmitting the second report comprises: obtaining one or more bits that indicate the set of channel measurements comprises predicted channel measurements or actual channel measurements.

Aspect 31: An apparatus for wireless communication at a UE, comprising a processor; memory coupled with the processor; and instructions stored in the memory and executable by the processor to cause the apparatus to perform a method of any of aspects 1 through 14.

Aspect 32: An apparatus for wireless communication at a UE, comprising at least one means for performing a method of any of aspects 1 through 14.

Aspect 33: A non-transitory computer-readable medium storing code for wireless communication at a UE, the code comprising instructions executable by a processor to perform a method of any of aspects 1 through 14.

Aspect 34: An apparatus for wireless communication at a UE, comprising a processor; memory coupled with the processor; and instructions stored in the memory and executable by the processor to cause the apparatus to perform a method of any of aspects 15 through 24.

Aspect 35: An apparatus for wireless communication at a UE, comprising at least one means for performing a method of any of aspects 15 through 24.

Aspect 36: A non-transitory computer-readable medium storing code for wireless communication at a UE, the code comprising instructions executable by a processor to perform a method of any of aspects 15 through 24.

Aspect 37: An apparatus for wireless communication at a network entity, comprising a processor; memory coupled with the processor; and instructions stored in the memory and executable by the processor to cause the apparatus to perform a method of any of aspects 25 through 28.

Aspect 38: An apparatus for wireless communication at a network entity, comprising at least one means for performing a method of any of aspects 25 through 28.

Aspect 39: A non-transitory computer-readable medium storing code for wireless communication at a network entity, the code comprising instructions executable by a processor to perform a method of any of aspects 25 through 28.

Aspect 40: An apparatus for wireless communication at a network entity, comprising a processor; memory coupled with the processor; and instructions stored in the memory and executable by the processor to cause the apparatus to perform a method of any of aspects 29 through 30.

Aspect 41: An apparatus for wireless communication at a network entity, comprising at least one means for performing a method of any of aspects 29 through 30.

Aspect 42: A non-transitory computer-readable medium storing code for wireless communication at a network entity, the code comprising instructions executable by a processor to perform a method of any of aspects 29 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor,
memory coupled with the processor; and
instructions stored in the memory and executable by the processor to cause the apparatus to:
transmit, to a network entity, a first report that indicates a predicted channel measurement associated with a reference signal resource;
determine that the predicted channel measurement satisfies a trigger condition, wherein the first report indicates a request to transmit a second report that indicates an actual channel measurement associated with the predicted channel measurement based at least in part on the predicted channel measurement satisfying the trigger condition; and
receive, from the network entity in response to the request, a grant of at least an uplink resource to transmit the second report.

2. The apparatus of claim 1, wherein the instructions to transmit the first report are executable by the processor to cause the apparatus to:
transmit the first report during a first duration, wherein the predicted channel measurement is associated with a second duration subsequent to the first duration.

3. The apparatus of claim 1, wherein the instructions are further executable by the processor to cause the apparatus to:
receive, from the network entity, a reference signal transmitted using a second reference signal resource associated with the reference signal resource, and
transmit, to the network entity using the uplink resource, the second report that indicates the actual channel measurement associated with the predicted channel measurement, wherein the actual channel measurement is of the reference signal.

4. The apparatus of claim 3, wherein:
the reference signal resource comprises a virtual resource, and
the second reference signal resource comprises a channel measurement resource.

5. The apparatus of claim 1, wherein the instructions are further executable by the processor to cause the apparatus to:
identify the trigger condition, wherein determining that the predicted channel measurement satisfies the trigger condition is based at least in part on identifying the trigger condition.

6. The apparatus of claim 5, wherein the instructions are further executable by the processor to cause the apparatus to:
receive, from the network entity, an indication of the trigger condition, wherein identifying the trigger condition is based at least in part on the received indication.

7. The apparatus of claim 5, wherein the instructions are further executable by the processor to cause the apparatus to:
transmit, to the network entity, an indication of the identified trigger condition.

8. The apparatus of claim 1, wherein the instructions to determine that the predicted channel measurement satisfies the trigger condition are executable by the processor to cause the apparatus to:
determine that a difference between the predicted channel measurement and a second predicted channel measurement associated with a second reference signal resource satisfies a threshold, wherein the predicted channel measurement and the second predicted channel measurement are associated with a same duration.

9. The apparatus of claim 8, wherein:
the first report indicates a plurality of actual channel measurements that are associated with a plurality of reference signal resources include the second reference signal resource, and the second reference signal resource corresponds to a strongest channel measurement of the plurality of actual channel measurements.

10. The apparatus of claim 8, wherein the second reference signal resource corresponds to a transmission configuration indicator state associated with a previously scheduled physical downlink control channel transmission or a previously scheduled physical downlink shared channel transmission.

11. The apparatus of claim 1, wherein the instructions to determine that the predicted channel measurement satisfies the trigger condition are executable by the processor to cause the apparatus to:
determine that a confidence level associated with the predicted channel measurement satisfies a threshold.

12. The apparatus of claim 1, wherein the first report comprises a bitmap or a combinatorial index that indicates the request.

13. The apparatus of claim 1, wherein the first report comprises a periodic channel state information report and the second report comprises an aperiodic channel state information report.

14. The apparatus of claim 1, wherein the reference signal resource comprises a channel measurement resource.

15. An apparatus for wireless communication at a user equipment (UE), comprising:
a processor,
memory coupled with the processor; and
instructions stored in the memory and executable by the processor to cause the apparatus to:
transmit, to a network entity, a first report that indicates at least a first predicted channel measurement associated with a first reference signal resource of a set of reference signal resources;
determine whether the first predicted channel measurement satisfies a trigger condition; and
transmit, to the network entity, a second report that indicates a first channel measurement associated with the first reference signal resource and indicates that the first channel measurement comprises a second predicted channel measurement or a first actual channel measurement, wherein the first channel measurement comprising the second predicted channel measurement or the first actual channel measurement is based at least in part on whether the first predicted channel measurement satisfies the trigger condition.

16. The apparatus of claim 15, wherein the instructions to determine whether the first predicted channel measurement satisfies the trigger condition are executable by the processor to cause the apparatus to:
determine that the first predicted channel measurement fails to satisfy the trigger condition, wherein the second report indicates that the first channel measurement comprises the first actual channel measurement based at least in part on the first predicted channel measurement failing to satisfy the trigger condition.

17. The apparatus of claim 15, wherein the instructions to determine whether the first predicted channel measurement satisfies the trigger condition are executable by the processor to cause the apparatus to:
determine that the first predicted channel measurement satisfies the trigger condition, wherein the second report indicates that the first channel measurement comprises the second predicted channel measurement based at least in part on the first predicted channel measurement satisfying the trigger condition.

18. The apparatus of claim 15, wherein the instructions to transmit the second report are executable by the processor to cause the apparatus to:
transmit a bit that indicates the first channel measurement comprises predicted channel measurements or actual channel measurements.

19. The apparatus of claim 15, wherein the instructions to transmit the second report are executable by the processor to cause the apparatus to:
transmit a first indication that the first channel measurement comprises the second predicted channel measurement or the first actual channel measurement; and
transmit a second indication that a second channel measurement comprises a third predicted channel measurement or a second actual channel measurement.

20.-24. (canceled)

25. An apparatus for wireless communication at a network entity, comprising:
a processor;
memory coupled with the processor; and
instructions stored in the memory and executable by the processor to cause the apparatus to:
obtain a first report that indicates a predicted channel measurement and a request to transmit a second report that indicates an actual channel measurement associated with the predicted channel measurement, wherein the predicted channel measurement is associated with a reference signal resource, and wherein the request is based at least in part on the predicted channel measurement satisfying a trigger condition;
outputting, in response to the request, a grant of at least an uplink resource to be used to transmit the second report; and
obtain the second report that indicates the actual channel measurement associated with the predicted channel measurement based at least in part on outputting the grant.

26.-30. (canceled)
